(19) United States
(12) Patent Application Publication
(10) Pub. No.: US 2023/0368052 A1
(43) Pub. Date: Nov. 16, 2023

(54) INFERENCE CALCULATION PROCESSING DEVICE AND INFERENCE CALCULATION PROCESSING METHOD

(71) Applicant: FANUC CORPORATION, Minamitsuru-gun, Yamanashi (JP)

(72) Inventor: Weijia LI, Yamanashi (JP)

(21) Appl. No.: 18/024,122

(22) PCT Filed: Sep. 21, 2021
(86) PCT No.: PCT/JP2021/034571

§ 371 Date: Mar. 1, 2023

(30) Foreign Application Priority Data
Sep. 25, 2020 (JP) 2020-161213

(51) Int. Cl. G06N 5/046; G06V 10/774; G06V 10/776; G10L 15/02; G10L 15/06

(52) U.S. Cl. CPC G06N 5/046; G06V 10/774; G06V 10/776; G10L 15/02; G10L 15/063

(57) ABSTRACT

The present invention executes an inference calculation process in a short time without a robot having to wait for prolonged periods of time. This inference calculation processing device inputs inferencing data into a trained model and executes a process of inference calculation on the inferencing data, wherein the inference calculation processing device comprises: an acquisition unit for acquiring the inferencing data and the trained model; a preprocessing unit for batching the acquired inferencing data and dividing the batches into a plurality of inferencing sub-data; and an execution unit for optimizing the order of the process of inference-calculating the plurality of inferencing sub-data and executing the process of inference-calculating the inferencing data in the optimized order of the inference calculation process on the basis of each of at least some of the plurality of inferencing sub-data and the trained model.

### TECHNICAL FIELD

The present invention relates to an inference calculation processing device and an inference calculation processing method.

### BACKGROUND ART

The use of a GPU (graphics processing unit) is essential in order to perform high-speed calculation processing of applications that use deep learning. However, the GPU is updated highly frequently and is difficult to incorporate into a product from the viewpoint of maintenance over a long period of time. Further, the GPU is expensive and leads to an increase in introduction costs. Picking of workpieces loaded in bulk using deep learning is preferably performed by means of a software application for use in a production line of a factory and an ordinary inexpensive CPU (central processing unit) such that high-speed inference can be performed to achieve a target cycle time of the production line at low costs.

In this respect, a technique is known in which workpieces loaded in bulk are picked up by way of a process including: generating and displaying a distance image of the workpieces loaded in bulk; performing machine learning using, as input data, three-dimensional point cloud data in the vicinity of a taught picking position in the displayed distance image, and using, as a label, an evaluation value according to teaching or an evaluation value according to the success or failure result of a picking operation; generating a trained model that receives an input of three-dimensional point cloud data and outputs an evaluation value of the three-dimensional point cloud data; and based on an evaluation value that the generated trained model outputs in response to an input three-dimensional point cloud data of a distance image clipped to the size of a predetermined zone, selecting a picking position corresponding to the clipped distance image with a high evaluation value. For example, see Patent Document 1.
Patent Document 1: Japanese Unexamined Patent Application, Publication No. 2019-58960

### DISCLOSURE OF THE INVENTION

### Problems to be Solved by the Invention

A distance image of a predetermined zone is clipped from a distance image, as mentioned above. On the other hand, once a size of input data for learning for use in machine learning is fixed, it is necessary to clip, from a distance image, a distance image data for input to the trained model (hereinafter, referred to also as a “clipped image”) in the same size as the input data for learning.

Further, each of pieces of three-dimensional point cloud data of all clipped images (picking position candidates) is input to the trained model to output each evaluation value, and a picking position corresponding to the clipped image with the high evaluation value is selected. In other words, all the clipped images (picking position candidates) are input to the trained model to perform inference calculation processing, and thus, a useless inference calculation is performed for clipped images (picking position candidates) that will not be selected/used due to a low evaluation value as a result of the inference calculation.

In particular, a distance image with high resolution (that is, with a large data size) and three-dimensional point cloud data are required in a case of workpieces having complicated shapes. In addition, a data size is large in a distance image and three-dimensional point cloud data acquired for large-sized workpieces, as well. For this reason, when inference calculation processing is performed on data with a large data size, a method of calculating all of the clipped images (picking position candidates) involves a useless calculation processing time for clipped images (picking position candidates) that will not be selected/used due to a low evaluation value as a result of the inference calculation. Thus, a total inference time is lengthened, and a robot and other devices in a production line of a factory are in a standby state for the lengthened period, resulting in a decrease in production efficiency.

Therefore, it is desirable to make it possible to execute inference calculation processing within a short time without putting a robot on standby for a long time.

### Means for Solving the Problems

One aspect of the present disclosure provides an inference calculation processing device that inputs inference data to a trained model and executes inference calculation processing for the inference data, the inference calculation processing device comprising: an acquisition unit configured to acquire the inference data and the trained model; a pre-processing unit configured to divide the acquired inference data into a plurality of pieces of inference sub-data by way of batch processing; and an execution unit configured to optimize an inference calculation processing sequence of the plurality of pieces of inference sub-data, and execute the inference calculation processing for the inference data according to the optimized inference calculation processing sequence, based on each of at least one of the plurality of pieces of inference sub-data and the trained model.

One aspect of the present disclosure provides an inference calculation processing method that is for inputting inference data to a trained model and executing inference calculation processing for the inference data, the inference calculation processing method being implementable by a computer, and comprising: an acquisition step of acquiring the inference data and the trained model; a pre-processing step of dividing the acquired inference data into a plurality of pieces of inference sub-data by way of batch processing; and an execution step of optimizing an inference calculation processing sequence of the plurality of pieces of inference sub-data, and executing the inference calculation processing for the inference data according to the optimized inference calculation processing sequence, based on each of at least one of the plurality of pieces of inference sub-data and the trained model.

### Effects of the Invention

According to an aspect, it is possible to execute inference calculation processing within a short time without putting a robot on standby for a long time.

### BRIEF DESCRIPTION OF THE DRAWINGS

FIG. 1 is a diagram showing an example of a configuration of a robot system according to a first embodiment;

FIG. 2 is a functional block diagram showing a functional configuration example of a trained model execution device according to the first embodiment;

FIG. 3 is a flowchart for describing inference calculation processing performed by the trained model execution device;

FIG. 4 is a functional block diagram showing a functional configuration example of a trained model execution device according to a second embodiment;

FIG. 5 is a flowchart for describing inference calculation processing performed by the trained model execution device;

FIG. 6 is a diagram showing an example of a configuration of a robot system according to a third embodiment;

FIG. 7 is a functional block diagram showing a functional configuration example of a trained model execution device according to the third embodiment;

FIG. 8 is a flowchart for describing inference calculation processing performed by the trained model execution device;

FIG. 9 is a functional block diagram showing a functional configuration example of a trained model execution device according to a modification example of the third embodiment in a case of also acquiring training image data;

FIG. 10 is a functional block diagram showing a functional configuration example of the trained model execution device in a case where inference data is voice data;

FIG. 11 is a functional block diagram showing a functional configuration example of the trained model execution device in a case where inference data is character data;

FIG. 12 is a functional block diagram showing a functional configuration example of the trained model execution device in a case where inference data is voice data;

FIG. 13 is a functional block diagram showing a functional configuration example of the trained model execution device in a case where inference data is character data; and

FIG. 14 is a functional block diagram showing a functional configuration example of a trained model execution device in a case of also acquiring training image data.

### PREFERRED MODE FOR CARRYING OUT THE INVENTION

First to third embodiments will be described in detail with reference to the drawings.

Here, the embodiments have a common configuration in which inference calculation processing is executed within a short time using a trained model that specifies picking positions of a plurality of workpieces loaded and stacked in bulk, without putting a robot on standby for a long time.

However, in the inference calculation processing of the first embodiment, based on a size of training image data, which is training data used in machine learning generating a trained model, inference image data obtained by capturing a plurality of workpieces loaded and stacked in bulk is divided using batch processing, a feature amount is extracted by way of image feature analysis with respect to a plurality of pieces of inference sub-image data generated by the division, an evaluation score is assigned to each of the plurality of pieces of inference sub-image data based on the matching result between the feature amount of each of the plurality of pieces of inference sub-image data and the feature amount extracted from the image feature analysis with respect to the training image data, and an inference calculation processing sequence for the plurality of pieces of inference sub-image data is optimized based on the priority given depending on the evaluation score. The second embodiment is different from the first embodiment in that inference image data is subjected to image processing to extract feature points, the inference image data is divided by the batch processing according to the number of the feature points, and the evaluation score is assigned to each of the plurality of pieces of inference sub-image data based on the number of the feature points. The third embodiment is different from the first and second embodiments in that inference image data is divided by batch processing based on three-dimensional point cloud data (or distance image data) corresponding to workpieces loaded and stacked in bulk and acquired by a three-dimensional measurement device or the like, and an evaluation score is assigned to each of a plurality of pieces of inference sub-image data based on a height (hereinafter, also referred to as a “predetermined height”) from a bottom of a container in each of the plurality of pieces of divided inference sub-image data.

First, the first embodiment will be described in detail below, and then differences of the second and third embodiments from the first embodiment will be described.

### First Embodiment

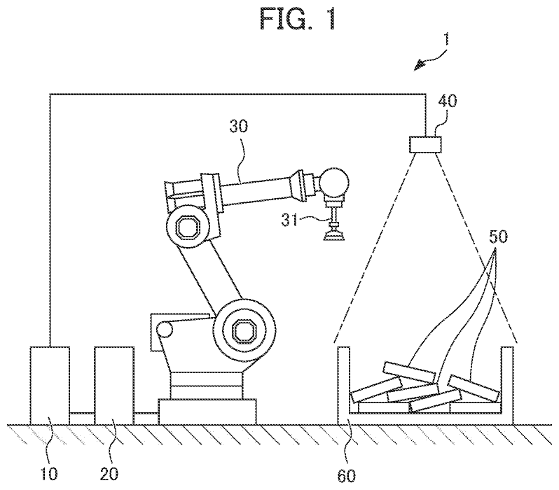

FIG. 1 is a diagram showing an example of a configuration of a robot system 1 according to the first embodiment. Here, a case will be illustrated in which a trained model generated by machine learning based on image data is executed in a case where a robot picks workpieces which are loaded in bulk in a container. The present invention is not limited to the case of executing the trained model generated by machine learning based on image data for allowing the robot to pick the workpieces loaded in bulk in the container. For example, the present invention is applicable not only such control of the motion of robot, but also to a case of executing a trained model generated by machine learning based on image data in a system that performs inference for executing arbitrary tasks based on image data.

Further, for example, as will be described below, the present invention is also applicable to a case of executing a trained model generated by machine learning based on voice data in a system that performs inference for executing arbitrary tasks based on voice data. In addition, the present invention is also applicable to a case of executing a trained model generated by machine learning based on character data in a system that performs inference for executing arbitrary tasks based on character data.

As shown in FIG. 1, the robot system 1 includes a trained model execution device 10 as an inference calculation processing device, a robot control device 20, a robot 30, an image capturing device 40, a plurality of workpieces 50, and a container 60.

The trained model execution device 10, the robot control device 20, the robot 30, and the image capturing device 40 may be directly connected to each other via a connection interface (not shown). The trained model execution device 10, the robot control device 20, the robot 30, and the image capturing device 40 may be connected to each other via a network (not shown) such as a LAN (local area network) or the Internet. In this case, the trained model execution device 10, the robot control device 20, the robot 30, and the image capturing device 40 are provided with a communication unit (not shown) for mutual communication through such connection. For ease of description, FIG. 1 depicts the trained model execution device 10 and the robot control device 20 independently from each other, and the trained model execution device 10 in this case may be configured by a computer, for example. Without being limited to such a configuration, for example, the trained model execution device 10 may be mounted inside the robot control device 20 to be integrated with the robot control device 20.

The robot control device 20 is a device known to those skilled in the art and is configured to control a motion of the robot 30. For example, the robot control device 20 receives, from the trained model execution device 10, picking position information on a workpiece 50 selected from workpieces 50 loaded in bulk by the trained model execution device 10 to be described below. The robot control device 20 generates a control signal for controlling a motion of the robot 30 so as to pick the workpiece 50 located at the picking position received from the trained model execution device 10. Then, the robot control device 20 outputs the generated control signal to the robot 30.

The robot control device 20 may include the trained model execution device 10 as will be described below.

The robot 30 is a robot that moves under the control of the robot control device 20. The robot 30 includes a base portion for rotating around a vertical axis, an arm that moves and rotates, and a picking hand 31 attached to the arm and configured to hold the workpiece 50. In FIG. 1, the picking hand 31 attached to the robot 30 is an air-suction type picking hand, but may be a grip-type picking hand, or may be a magnetic-type hand that picks an iron workpiece using a magnetic force.

The robot 30 drives the arm and the picking hand 31 according to the control signal output by the robot control device 20, and moves the picking hand 31 to the picking position selected by the trained model execution device 10 to hold one of the workpieces 50 loaded in bulk and pick it out of the container 60.

A transfer destination of the picked workpieces 50 is not shown in the drawings. In addition, since the specific configuration of the robot 30 is well known to those skilled in the art, a detailed description thereof is omitted herein.

Further, the present description is based on the precondition that the trained model execution device 10 and the robot control device 20 associate, by calibration performed in advance, a machine coordinate system for controlling the robot 30 with a camera coordinate system indicating the picking position of the workpieces 50.

The image capturing device 40 is a digital camera or the like, and captures two-dimensional image data obtained by projecting the workpieces 50 loaded in bulk in the container 60 onto a plane vertical to an optical axis of the image capturing device 40. The image data captured by the image capturing device 40 may be a visible light image such as an RGB color image, a grayscale image, or a depth image. Further, the image capturing device 40 may include an infrared sensor to capture a thermal image, or may include an ultraviolet sensor to capture an ultraviolet image for inspection of scratches or spots on a surface of an object. The image capturing device 40 may include an X-ray camera sensor to capture an X-ray image, or may include an ultrasonic sensor to capture an ultrasonic image.

The image capturing device 40 may be a three-dimensional measurement device such as a stereo camera, as will be described below.

The workpieces 50 are randomly placed in the container 60, such as in a state of being loaded in bulk. The workpiece 50 is not particularly limited to a specific shape as long as it can be held by the picking hand 31 attached to the arm of the robot 30.

### <Trained Model Execution Device 10>

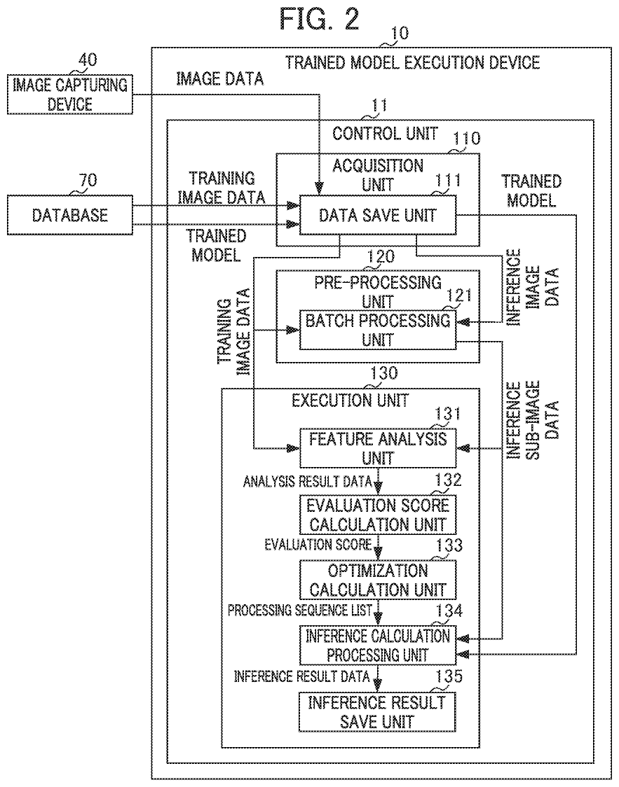

FIG. 2 is a functional block diagram showing a functional configuration example of the trained model execution device 10 according to the first embodiment.

The trained model execution device 10 is a computer known to those skilled in the art, and includes a control unit 11 as shown in FIG. 2. The control unit 11 includes an acquisition unit 110, a pre-processing unit 120, and an execution unit 130. The acquisition unit 110 includes a data save unit 111. The pre-processing unit 120 includes a batch processing unit 121. The execution unit 130 includes a feature analysis unit 131, an evaluation score calculation unit 132, an optimization calculation unit 133, an inference calculation processing unit 134, and an inference result save unit 135.

### <Control Unit 11>

The control unit 11 includes a CPU (central processing unit), a ROM, a RAM (random access memory), and a CMOS (complementary metal-oxide-semiconductor) memory, which are known to those skilled in the art and are communicable with each other via a bus.

The CPU is a processor that performs overall control for the trained model execution device 10. The CPU reads a system program and an application program stored in the ROM via the bus, and performs overall control for the trained model execution device 10 according to the system program and the application program. Thus, as shown in FIG. 2, the control unit 11 is configured to implement functions of the acquisition unit 110, the pre-processing unit 120, and the execution unit 130. Further, the acquisition unit 110 is configured to implement a function of the data save unit 111. The pre-processing unit 120 is configured to implement a function of the batch processing unit 121. The execution unit 130 is configured to implement functions of a feature analysis unit 131, an evaluation score calculation unit 132, an optimization calculation unit 133, an inference calculation processing unit 134, and an inference result save unit 135. The RAM stores various data, for example, temporary calculation data and display data. The CMOS memory is backed up by a battery (not shown), and is configured as a non-volatile memory that retains the stored state even when the trained model execution device 10 is turned off.

### <Acquisition Unit 110>

The acquisition unit 110 acquires image data as inference data from the image capturing device 40, and acquires a trained model and training image data that has been used in machine learning to generate the trained model, from a database 70 on a cloud or an edge device.

The acquisition unit 110 may further be configured to include a data save unit 111 such as a HDD or a USB memory, and may be configured to save the acquired trained model in the data save unit 111. For example, the acquisition unit 110 may acquire a trained model recorded in a recording medium such as a HDD or a USB memory from the database 70 on the cloud or the edge device via a network such as a LAN, and may copy and save the acquired trained model in the data save unit 111.

Further, for example, the acquisition unit 110 may acquire training image data recorded in a recording medium such as a HDD or a USB memory from the database 70 on the cloud or the edge device via a network such as a LAN, and may copy and save the acquired training image data in the data save unit 111.

Further, the acquisition unit 110 may acquire, for example, the image data captured from the image capturing device 40, and may copy and save the acquired image data as inference image data in the data save unit 111.

The acquisition unit 110 acquires the image data from the image capturing device 40, but may acquire three-dimensional point cloud data, distance image data or the like as will be described below.

### <Pre-Processing Unit 120>

The pre-processing unit 120 includes the batch processing unit 121, and the batch processing unit 121 may be configured to perform batch processing on the inference data based on the training image data acquired by the acquisition unit 110 and divide it into a plurality of pieces of inference sub-image data.

Specifically, the batch processing unit 121 may perform batch processing on the inference image data, for example, based on a data size of the training image data used for the machine learning and divide it into a plurality of pieces of inference sub-image data.

### <Execution Unit 130>

The execution unit 130 may be configured to optimize an inference calculation processing sequence of the plurality of pieces of the inference sub-image data divided by the batch processing in the pre-processing unit 120, and execute inference calculation processing of the inference data based on each of pieces of inference sub-image data that are necessary in accordance with the optimized inference calculation processing sequence and based on the trained model until a search target specified in advance is achieved.

For example, the execution unit 130 may be configured to perform image feature analysis on a neighboring image near a labeled teaching position on the training image data and each of the plurality of inference sub-image data divided by the batch processing in the pre-processing unit 120, assign an evaluation score to each of the plurality of inference sub-image data based on a matching result of the extracted feature amount, and optimize the inference calculation processing sequence of the plurality of inference sub-image data based on priority determined depending on a magnitude of the evaluation score assigned to each of the plurality of inference sub-image data.

Specifically, for example, since a label is attached to the training image data to indicate a position where the workpiece 50 can be picked, the feature analysis unit 131 of the execution unit 130 performs image processing on a neighboring image zone including the picking position indicated by the label, included in the training image data. The feature analysis unit 131 extracts a feature amount (hereinafter, referred to as “local feature amount”) A specified by the image processing, for example. Further, the feature analysis unit 131 performs image processing on n pieces of inference sub-image data IMG1, IMG2, . . . , and IMGn divided by the batch processing in the pre-processing unit 120, and extracts a local feature amount (n being an integer of 2 or more). For example, it is assumed that the feature analysis unit 131 extracts local feature amounts A11 and A12 from the inference sub-image data IMG1, extracts local feature amounts A21, A22, and A23 from the inference sub-image data IMG2, and extracts local feature amounts A31, A32, A33, and A34 from the inference sub-image data IMG3. The feature analysis unit 131 performs matching processing between each of the extracted local feature amounts A11, A12, A21, A22, A23, A31, A32, A33, and A34 and the local feature amount A of the training image data, and outputs analysis result data of the matching processing to the evaluation score calculation unit 132, which will be described below.

The evaluation score calculation unit 132 of the execution unit 130 receives the analysis result data output by the feature analysis unit 131, and assigns a high evaluation score (for example, 70 points) to the inference sub-image data IMG2 when the inference sub-image data IMG2 includes the local feature amount (for example, A22) with a high matching degree, for example. Further, the evaluation score calculation unit 132 assigns a high evaluation score (for example, 80 points) to the inference sub-image data IMG3 when the one piece of inference sub-image data IMG3 includes the plurality of local feature amounts (for example, A32 and A34) with a high matching degree, for example. The evaluation score calculation unit 132 outputs the evaluation scores assigned in this way to the optimization calculation unit 133, which will be described below.

Based on information on the evaluation score output by the evaluation score calculation unit 132, the optimization calculation unit 133 of the execution unit 130 gives high priority to the inference sub-image data with the high evaluation score such that the inference calculation processing is preferentially performed in descending order of the evaluation score. The optimization calculation unit 133 optimizes the inference calculation processing sequence of the n pieces of inference sub-image data divided by the batch processing in the pre-processing unit 120, and generates a processing sequence list indicating the optimized inference calculation processing sequence. The optimization calculation unit 133 outputs the generated processing sequence list to the inference calculation processing unit 134, which will be described below.

The optimization calculation unit 133 may delete inference sub-image data having a low evaluation score from the processing sequence list such that the inference sub-image data is not subjected to the inference calculation processing.

Based on the information on the processing sequence list received from the optimization calculation unit 133, the n pieces of inference sub-image data divided by the batch processing in the pre-processing unit 120, and the trained model acquired by the acquisition unit 110, the inference calculation processing unit 134 of the execution unit 130 performs inference calculation processing on a necessary quantity of inference sub-image data from the n pieces of inference sub-image data in descending order of the processing sequence list until a search target specified in advance is achieved (for example, until picking positions of ten workpieces 50 are found). The inference calculation processing unit 134 outputs inference result data of the inference calculation processing to the inference result save unit 135, which will be described below.

The inference result save unit 135 of the execution unit 130 receives the inference result data from the inference calculation processing unit 134, and saves the same.

Since there is a high possibility that a better picking position candidate having the same feature as the teaching position on the training image data exists in the inference sub-image data with a high evaluation score, the trained model execution device 10 preferentially performs the inference calculation processing on the inference sub-image data in descending order of the evaluation score. Thereby, the trained model execution device 10 can quickly complete the search for the predesignated number of workpieces 50 to be picked (hereinafter, also referred to as “predetermined number of candidates”), finish the inference calculation processing early, and thus shorten the inference calculation processing time. In other words, since there is a low possibility that a better picking position candidate having the same feature as the teaching position on the training image data exists in the inference sub-image data with a low evaluation score, the trained model execution device 10 does not perform the inference calculation processing on the inference sub-image data with a low evaluation score, thereby eliminating useless inference calculation processing and shortening the inference calculation processing time. That is, the trained model execution device 10 can achieve the inference calculation processing at a high speed by optimizing the inference calculation processing sequence based on the priority depending on the evaluation score.

The predetermined number of candidates is preferably determined according to the accuracy and processing speed required for the inference calculation processing, but may be determined according to production requirements of a production line of the factory.

### <Inference Calculation Processing of Trained Model Execution Device 10>

A description will be given below with respect to operations related to the inference calculation processing performed by the trained model execution device 10 according to the present embodiment.

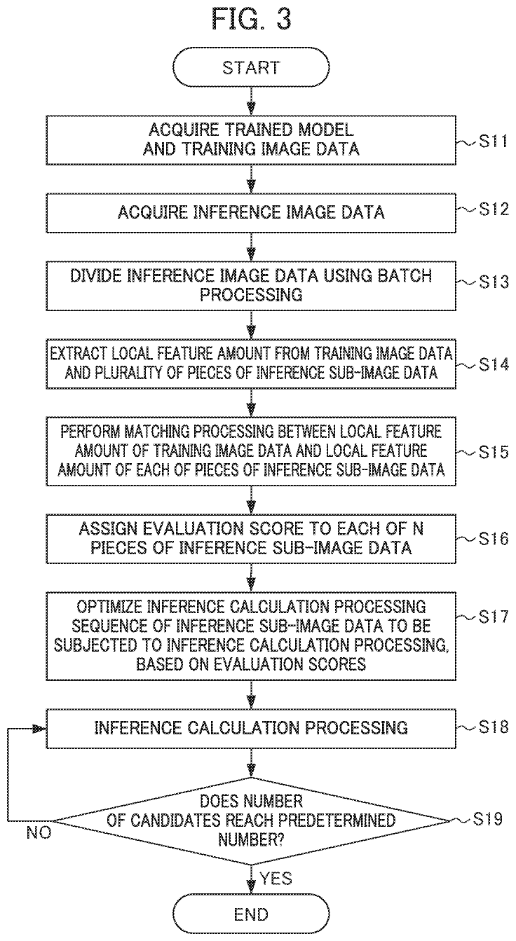

FIG. 3 is a flowchart for describing the inference calculation processing performed by the trained model execution device 10.

In Step S11, the acquisition unit 110 acquires a trained model and training image data from the database 70.

In Step S12, the acquisition unit 110 acquires inference image data from the image capturing device 40.

In Step S13, the batch processing unit 121 of the pre-processing unit 120 divides, based on the training image data, the inference image data acquired in Step S12 into n pieces of inference sub-image data by way of the batch processing.

In Step S14, the feature analysis unit 131 of the execution unit 130 performs image feature analysis on the training image data and the n pieces of inference sub-image data, and extracts a local feature amount from the training image data and the n pieces of inference sub-image data.

In Step S15, the feature analysis unit 131 performs matching processing between the local feature amount of the training image data and the local feature amount of each of the inference sub-image data, and outputs the analysis result data of the matching processing to the evaluation score calculation unit 132.

In Step S16, the evaluation score calculation unit 132 assigns, based on the analysis result data output in Step S15, an evaluation score corresponding to the matching degree with the local feature amount of the training image data to each of the n pieces of inference sub-image data.

In Step S17, the optimization calculation unit 133 optimizes, based on the information on the evaluation score assigned in Step S16, an inference calculation processing sequence of the plurality of inference sub-image data to be subjected to the inference calculation processing, and generates a processing sequence list.

In Step S18, the inference calculation processing unit 134 performs inference calculation processing, based on information on the processing sequence list generated in Step S17, the inference sub-image data, and the trained model.

In Step S19, the inference calculation processing unit 134 determines whether the number of picking position candidates searched by the inference calculation processing in Step S18 has reached a predetermined number of candidates. When the number of picking position candidates has reached the predetermined number of candidates, the inference calculation processing ends. On the other hand, when the number of picking position candidates is less than the predetermined number of candidates, the process returns to Step S18.

As described above, the trained model execution device 10 according to the first embodiment acquires the inference data from the image capturing device 40 and acquires the trained model and the training image data from the database 70. The trained model execution device 10 divides, based on the size of the training image data, the inference image data into the n pieces of inference sub-image data using the batch processing. The trained model execution device 10 extracts the local feature amount from the training image data and each of the n pieces of inference sub-image data, and performs the matching processing between the local feature amount extracted from the training image data and the local feature amount extracted from each of the inference sub-image data. The trained model execution device 10 assigns, based on the analysis result data in the matching processing, the evaluation score corresponding to the matching degree with the local feature amount of the training image data to each of the n pieces of inference sub-image data, and optimizes the inference calculation processing sequence of the plurality of inference sub-image data to be subjected to the inference calculation processing based on the information on the evaluation score.

Thus, the trained model execution device 10 can execute the inference calculation processing within a short time without putting the robot 30 on standby for a long time.

Further, the trained model execution device 10 can execute the inference at a high speed by means of an ordinary inexpensive CPU, and can achieve high production efficiency required for production line at low cost.

In the foregoing, the first embodiment has been described.

### Second Embodiment

The second embodiment will be described below. As described above, in the inference calculation processing according to the first embodiment, the inference image data is divided by the batch processing according to the size of the training image data, the feature amount is extracted by way of the image feature analysis for each of the plurality of inference sub-image data generated by the division, the evaluation score is assigned to each of the plurality of inference sub-image data based on the matching result between the feature amount of each of the plurality of inference sub-image data and the feature amount of the training image data, and the inference calculation processing sequence of the plurality of inference sub-image data is optimized based on the priority depending on the value of the assigned evaluation score. The second embodiment is different from the first embodiment in that specific feature points are extracted by image processing of the inference image data, inference image data is divided by batch processing according to the number of extracted feature points, and an evaluation score is assigned to each of a plurality of pieces of inference sub-image data based on the number of feature points included in each zone.

Thus, a trained model execution device 10a can execute inference calculation processing within a short time without putting a robot 30 on standby for a long time.

The second embodiment will be described below.

As in the case of the first embodiment, a robot system 1 according to the second embodiment includes the trained model execution device 10a, a robot control device 20, the robot 30, an image capturing device 40, a plurality of workpieces 50, and a container 60.

<Trained Model Execution Device 10a>

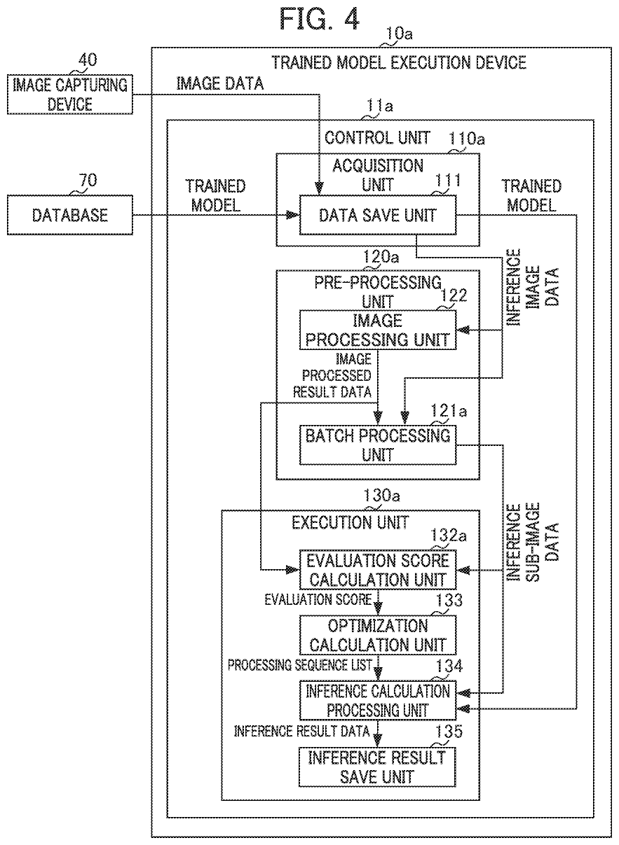

FIG. 4 is a functional block diagram showing a functional configuration example of the trained model execution device 10a according to the second embodiment. Components having functions similar to those of the trained model execution device 10 in FIG. 2 are denoted by the same reference numerals, and will not be described in detail.

As in the trained model execution device 10 according to the first embodiment, the trained model execution device 10a includes a control unit 11a. Further, the control unit 11a includes an acquisition unit 110a, a pre-processing unit 120a, and an execution unit 130a. The acquisition unit 110a includes a data save unit 111. The pre-processing unit 120a includes a batch processing unit 121a and an image processing unit 122. The execution unit 130a includes an evaluation score calculation unit 132a, an optimization calculation unit 133, an inference calculation processing unit 134, and an inference result save unit 135.

<Acquisition Unit 110a>

The acquisition unit 110a acquires image data as inference data from the image capturing device 40, and acquires a trained model from a database 70 on a cloud or an edge device. The acquisition unit 110a saves the acquired trained model and image data in the data save unit 111.

The data save unit 111 has a function equivalent to that of the data save unit 111 according to the first embodiment.

<Pre-Processing Unit 120a>

The pre-processing unit 120a may be configured to acquire the image data as inference image data from the data save unit 111 of the acquisition unit 110a, for example, perform image processing on the acquired inference image data, and divide the inference image data into a plurality of pieces of inference sub-image data using batch processing based on the image processed result.

Specifically, for example, the image processing unit 122 of the pre-processing unit 120a may perform image processing on the inference image data to extract features such as edges, corners and feature points, and output the features as image processed result data. As an example, a case will be described below in which the image processing unit 122 extracts a specific feature point from the entire zone of the inference image data. As shown in FIG. 1, for example, when the inference image data is an image obtained by capturing workpieces 50 loaded in bulk in the container 60, it can be predicted that there is a high possibility that a local image zone with a small number of extracted feature points contains almost none of the workpieces 50 but includes an image of one large plane (for example, the bottom of the container 60) with uniform brightness and equal pixel values. In this case, even when the trained model execution device 10a performs inference calculation processing on the image zone, it is probable that the workpieces 50 to be picked cannot be found, and thus, time is spent on useless inference calculation processing. In other words, the trained model execution device 10a analyzes a positional distribution of the feature points extracted by the image processing unit 122, and can specify a local image zone where more feature points are concentrated, that is, a local image zone where a large number of the workpieces 50 are present.

The case has been described as an example in which the image processing unit 122 performs the image processing on the inference image data to extract the feature points, but this is a non-limiting example. For example, the image processing unit 122 may improve efficiency by changing features to be extracted by the image processing according to the actual shape of the workpiece 50.

The batch processing unit 121a performs processing of dividing the inference image such that the local image zone having the feature points concentrated on the inference image is defined as one inference sub-image, and processing of dividing the inference image such that the local image zone having few or no feature point is defined as one inference sub-image. Thereby, the inference image data may be divided into a plurality of pieces of inference sub-image data such that the local image zone that is likely to contain many workpieces 50 is defined as one inference sub-image and the local image zone containing few or no workpiece 50 is defined as one inference sub-image, and may be output to the execution unit 130a. The batch processing unit 121a may determine, based on a preset threshold, whether the feature points are concentrated or sparse on the inference image data; for example, the batch processing unit 121a may determine that the number of feature points is large when exceeding a threshold D1, and determine that the number of feature points is small when being less than a threshold D2 (D2<D1).

Thus, at a stage of the batch processing for the inference image data, the local image zone that should be preferentially subjected to the inference calculation processing can be distinguished from the local image zone in which the target workpiece cannot be found in spite of the inference calculation and for which the inference calculation will be wasted, and the batch processing can be optimized such that an inference calculation processing sequence, which will be described below, can be optimized efficiently and smoothly.

Specifically, at the stage of the batch processing for the inference image data, the inference sub-image data in which the workpieces 50 are highly likely to be found and which should be preferentially subjected to the inference calculation processing is distinguished from the inference sub-image data in which the target workpiece 50 cannot be found in spite of the inference calculation and for which the inference calculation will be wasted, and thus, the execution unit 130a, which will be described below, can optimize the inference calculation processing sequence efficiently and smoothly.

<Execution Unit 130a>

The execution unit 130a may be configured to optimize an inference calculation processing sequence of a plurality of pieces of the inference sub-image data based on the image processed result data output by the image processing unit 122 in the pre-processing unit 120a, and execute inference calculation processing of the inference data based on each of pieces of the inference sub-image data that are necessary in accordance with the optimized inference calculation processing sequence and based on the trained model until a search target specified in advance is achieved.

Specifically, as described above, it is assumed that the batch processing unit 121a of the pre-processing unit 120a extracts feature points from an inference image obtained by photographing the workpieces 50 randomly loaded in the above-described container 60, and divides the inference image data into a plurality of pieces to generate and output a plurality of pieces of inference sub-image data. The execution unit 130a includes an evaluation score calculation unit 132a, and the evaluation score calculation unit 132a may assign a high evaluation score to the inference sub-image data having a large number of feature points, and assign a low evaluation score to the inference sub-image data having a small number of feature points.

Thus, as in the optimization calculation unit 133 in FIG. 2, the optimization calculation unit 133 of the execution unit 130a generates a processing sequence list in descending order of the evaluation scores assigned by the evaluation score calculation unit 132a, and outputs the processing sequence list.

As in the inference calculation processing unit 134 in FIG. 2, the inference calculation processing unit 134 of the execution unit 130a performs the inference calculation processing based on the information on the processing sequence list, the plurality of pieces of inference sub-image data, and the trained model, and saves the inference result data in the inference result save unit 135.

As described above, the trained model execution device 10a preferentially performs the inference calculation processing on the inference sub-image data that has a large number of extracted feature points and is likely to contain many workpieces 50, and does not perform the inference calculation processing on the inference sub-image data that has a small number of feature points and contains few or no workpiece 50, thereby making it possible to shorten the inference calculation processing time for finding the predetermined number of candidates for the predesignated workpieces 50 to be picked from the inference image data.

Thus, the trained model execution device 10a can find a predetermined number of candidates for the predesignated workpiece 50 to be picked from the inference image data, and finish the inference calculation processing early to shorten the time of inference calculation processing.

<Inference Calculation Processing of Trained Model Execution Device 10a>

A description will be given below with respect to operations related to the inference calculation processing performed by the trained model execution device 10a according to the present embodiment.

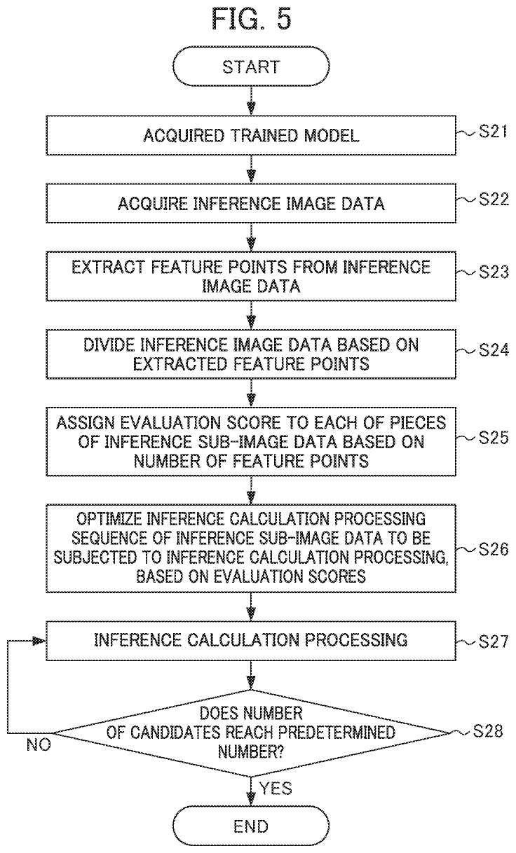

FIG. 5 is a flowchart for describing the inference calculation processing performed by the trained model execution device 10a.

Processing in Steps S26 to S28 is the same as that in Steps S17 to S19 of the first embodiment shown in FIG. 3, and a description of Steps S26 to S28 is omitted.

In Step S21, the acquisition unit 110a acquires a trained model from the database 70.

In Step S22, the acquisition unit 110a acquires inference image data from the image capturing device 40.

In Step S23, the image processing unit 122 of the pre-processing unit 120a performs image processing on the inference image data acquired in Step S22, and extracts feature points from the entire zone of the inference image data.

In Step S24, the batch processing unit 121a of the pre-processing unit 120a performs, based on the feature points extracted in Step S23, processing of dividing the inference image such that the local image zone having the feature points concentrated on the inference image data acquired in Step S22 is defined as one inference sub-image, and processing of dividing the inference image data such that the local image zone having few or no feature point is defined as one inference sub-image.

In Step S25, the evaluation score calculation unit 132a assigns an evaluation score to each of the pieces of inference sub-image data divided in Step S24 based on the number of feature points.

As described above, the trained model execution device 10a according to the second embodiment acquires the inference image data from the image capturing device 40 and acquires the trained model from the database 70. The trained model execution device 10a performs the image processing on the acquired inference image data, extracts the feature points from the entire zone of the inference image data, and divides, based on the extracted feature points, the inference image data into the inference sub-image data in which the feature points are concentrated and the inference sub-image data in which few or no feature point is present. Based on the number of feature points in each of the inference sub-image zones, the trained model execution device 10a assigns an evaluation score to each of the pieces of inference sub-image data generated by dividing the inference image data, and optimizes the inference calculation processing sequence of the plurality of pieces of inference sub-image data subjected to the inference calculation processing based on the information on the assigned evaluation score.

Thus, a trained model execution device 10a can execute inference calculation processing within a short time without the robot 30 waiting for a long time.

Further, the trained model execution device 10a can execute the inference at a high speed by means of an ordinary inexpensive CPU, and can achieve high production efficiency required for production line at low cost.

In the foregoing, the second embodiment has been described.

### Third Embodiment

The third embodiment will be described below. As described above, in the inference calculation processing according to the first embodiment, the inference image data is divided by the batch processing according to the size of the training image data, the feature amount is extracted by way of the image feature analysis for each of the plurality of divided inference sub-image data, the evaluation score is assigned to each of the plurality of inference sub-image data based on the matching result between the feature amount of each of the plurality of inference sub-image data and the feature amount of the training image data, and the inference calculation processing sequence of the plurality of inference sub-image data is optimized based on the priority depending on the value of the assign evaluation score. In the second embodiment, the feature points are extracted by the image processing of the inference image data, the inference image data is divided by the batch processing according to the number of feature points, and the evaluation score is assigned to each of the plurality of pieces of inference sub-image data based on the number of feature points. On the other hand, the third embodiment is different from the first and second embodiments in that inference image data is divided by batch processing based on three-dimensional point cloud data (or distance image data) corresponding to workpieces loaded and stacked in bulk and acquired by a three-dimensional measurement device 45 and that an evaluation score is assigned to each of a plurality of pieces of inference sub-image data based on a predetermined height of each of the plurality of pieces of divided inference sub-image data.

Thus, a trained model execution device 10b according to the third embodiment can execute inference calculation processing within a short time without putting a robot 30 on standby for a long time.

The third embodiment will be described below.

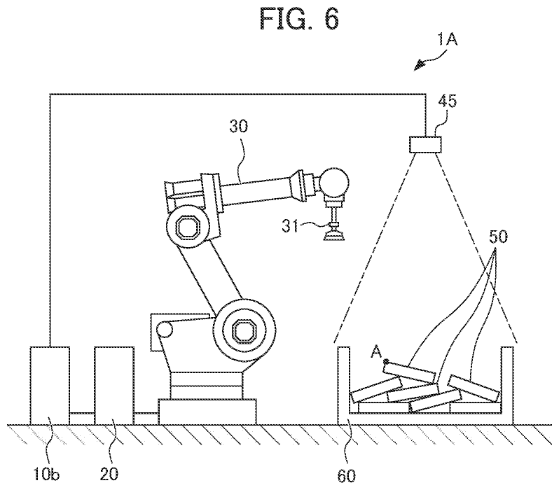

FIG. 6 is a diagram showing an example of a configuration of a robot system 1A according to the third embodiment. Components having functions similar to those of the robot system 1 in FIG. 1 are denoted by the same reference numerals, and will not be described in detail.

As shown in FIG. 6, the robot system 1A includes the trained model execution device 10b, a robot control device 20, the robot 30, the three-dimensional measurement device 45, a plurality of workpieces 50, and a container 60.

The robot control device 20 and the robot 30 have functions equivalent to those of the robot control device 20 and the robot 30 according to the first embodiment.

The three-dimensional measurement device 45 may be configured to acquire three-dimensional information (hereinafter, referred to also as a “distance image”) having, as pixel values, values each obtained by conversion from a distance between a plane vertical to an optical axis of the three-dimensional measurement device 45 and each of points on surfaces of the workpieces 50 loaded in bulk in the container 60. For example, as shown in FIG. 6, a pixel value of a point A of the workpiece 50 on a distance image is obtained by converting a distance (a height from the three-dimensional measurement device 45) between the three-dimensional measurement device 45 and the point A of the workpiece 50 in a Z-axis direction of a three-dimensional coordinate system (X, Y, Z) of the three-dimensional measurement device 45. In other words, the Z-axis direction of the three-dimensional coordinate system (X, Y, Z) is an optical axis direction of the three-dimensional measurement device 45. Further, the three-dimensional measurement device 45 may be constituted by, for example, a stereo camera, one camera fixed to a hand of the robot 30 or a movable device, or a combination of one camera and a distance sensor such as a laser scanner or a sound wave sensor, and may acquire three-dimensional point cloud data of the plurality of workpieces 50 loaded in the container 60. The three-dimensional point cloud data acquired in this way can be displayed in a 3D view that can be checked from every viewpoint in a three-dimensional space, and is discretized data that allows a state where the plurality of workpieces 50 loaded in the container 60 are stacked to be checked three-dimensionally.

In addition, the three-dimensional measurement device 45 may acquire a two-dimensional image such as a grayscale image or an RGB image together with the three-dimensional point cloud data or the distance image. The robot system 1A may include an image capturing device (not shown) such as a digital camera different from the three-dimensional measurement device 45, and the trained model execution device 10b may acquire not only the three-dimensional point cloud data or the distance image from the three-dimensional measurement device 45 but also the two-dimensional image from an image capturing device (not shown).

<Trained Model Execution Device 10b>

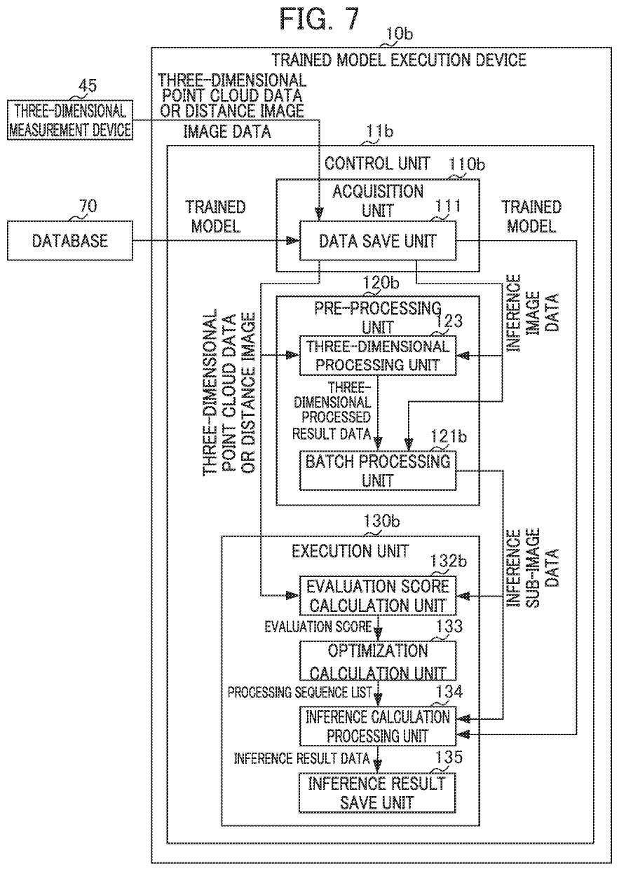

FIG. 7 is a functional block diagram showing a functional configuration example of the trained model execution device 10b according to the third embodiment. Components having functions similar to those of the trained model execution device 10 in FIG. 2 are denoted by the same reference numerals, and will not be described in detail.

The trained model execution device 10b includes a control unit 11b. The control unit 11b includes an acquisition unit 110b, a pre-processing unit 120b, and an execution unit 130b. The acquisition unit 110b includes a data save unit 111. The pre-processing unit 120b includes a batch processing unit 121b and a three-dimensional processing unit 123. The execution unit 130b includes an evaluation score calculation unit 132b, an optimization calculation unit 133, an inference calculation processing unit 134, and an inference result save unit 135.

<Acquisition Unit 110b>

The acquisition unit 110b acquires not only the image data as inference data but also the three-dimensional point cloud data or the distance image from three-dimensional measurement device 45. The acquisition unit 110b acquires a trained model from a database 70 on a cloud or an edge device. The acquisition unit 110b saves the acquired trained model, the three-dimensional point cloud data or the distance image, and the image data in the data save unit 111.

The data save unit 111 has a function equivalent to that of the data save unit 111 according to the first embodiment.

<Pre-Processing Unit 120b>

The pre-processing unit 120b may be configured to optimize the batch processing for the inference image data based on the three-dimensional point cloud data or the distance image data, and generate a plurality of pieces of inference sub-image data.

Specifically, the three-dimensional processing unit 123 of the pre-processing unit 120b measures two-dimensionally or three-dimensionally the plurality of workpieces 50 loaded in bulk in the container 60 to compare the acquired inference image data with the acquired three-dimensional point cloud data (or distance image data). Thus, the three-dimensional processing unit 123 can analyze distribution of heights (referred to also as a “predetermined heights”) from the bottom of the container 60 as three-dimensional positions in the real world corresponding to the respective pixel positions on the inference image data. The three-dimensional processing unit 123 outputs the analysis result of the distribution of the predetermined heights to the batch processing unit 121b, as three-dimensional processed result data.

Here, the batch processing unit 121b may receive the three-dimensional processed result data including the distribution information on the predetermined heights, and divide the inference image data into a plurality of pieces of inference sub-image data while reflecting differences in the predetermined heights corresponding to the respective pixel positions on the inference image data.

Specifically, at the stage of the batch processing for the inference image data, the inference image data is divided into inference sub-image data that contains a large number of the workpieces 50 and should be preferentially subjected to the inference calculation processing, and inference sub-image data that contains few or no workpiece 50 and for which the inference calculation will be wasted, thereby allowing an execution unit 130b, which will be described below, to optimize the inference calculation processing sequence efficiently and smoothly.

Preferably, the above-described threshold is appropriately determined according to the accuracy and the processing speed required for the inference calculation processing, but may be determined according to production requirements of production lines of the factory.

<Execution Unit 130b>

The execution unit 130b may be configured to optimize an inference calculation processing sequence of the plurality of pieces of inference sub-image data based on the three-dimensional point cloud data or the distance image data, and execute inference calculation processing for the inference data based on each of pieces of the inference sub-image data that are necessary in accordance with the optimized inference calculation processing sequence and based on the trained model until a search target specified in advance is achieved.

For example, in a case where the plurality of workpieces 50 are loaded in bulk in the container 60, the evaluation score calculation unit 132b of the execution unit 130b may assign a high evaluation score to the inference sub-image data having the predetermined height equal to or higher than the threshold, and preferentially perform the inference calculation processing on the inference sub-image data with the high evaluation score. On the other hand, the evaluation score calculation unit 132b may assign a low evaluation score to the inference sub-image data having the predetermined height lower than the threshold, and optimize the inference calculation processing without performing the inference calculation processing on the inference sub-image data with the low evaluation score. Thus, the trained model execution device 10b can find a predetermined number of candidates for the predesignated workpiece 50 from a huge amount of image data within a short inference calculation processing time.

Incidentally, there may be a zone where three-dimensional data cannot be acquired (data missing) due to failure in three-dimensional measurement depending on the performance of the three-dimensional measurement device 45 or lighting conditions.

Therefore, the evaluation score calculation unit 132b may lower the priority of the inference calculation processing for the inference sub-image data, for which the corresponding three-dimensional data has a large number of data missing zones, in respect of the plurality of pieces of inference sub-image data output by the batch processing unit 121b of the pre-processing unit 120b. Thereby, the trained model execution device 10b can eliminate useless inference calculation processing and shorten the inference calculation processing time.

The optimization calculation unit 133, the inference calculation processing unit 134, and the inference result save unit 135 have functions equivalent to those of the optimization calculation unit 133, the inference calculation processing unit 134, and the inference result save unit 135 according to the first embodiment, respectively.

<Inference Calculation Processing of Trained Model Execution Device 10b>

A description will be given below with respect to operations related to the inference calculation processing performed by the trained model execution device 10b according to the present embodiment.

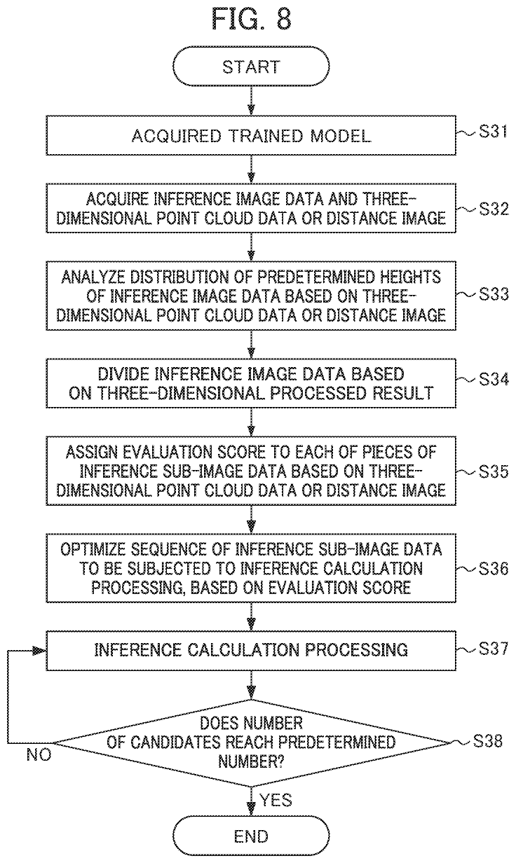

FIG. 8 is a flowchart for describing the inference calculation processing performed by the trained model execution device 10b.

Processing in Steps S36 to S38 is the same as that in Steps S17 to S19 of the first embodiment shown in FIG. 3, and a description of Steps S36 to S38 is omitted.

In Step S31, the acquisition unit 110b acquires a trained model from the database 70.

In Step S32, the acquisition unit 110b acquires inference image data and three-dimensional point cloud data or a distance image from the three-dimensional measurement device 45.

In Step S33, the three-dimensional processing unit 123 analyzes a distribution of predetermined heights of the inference image data based on the three-dimensional point cloud data or the distance image acquired in Step S32, and outputs three-dimensional processed result data.

In Step S34, the batch processing unit 121b divides the inference image data into a plurality of pieces of inference sub-image data based on the three-dimensional processed result data output in Step S33.

In Step S35, the evaluation score calculation unit 132b assigns an evaluation score to each of the pieces of inference sub-image data based on the three-dimensional point cloud data or the distance image.

As described above, the trained model execution device 10b according to the third embodiment acquires the inference image data and the three-dimensional point cloud data or the distance image from the three-dimensional measurement device 45 and acquires the trained model from the database 70. The trained model execution device 10b analyzes the distribution of the predetermined heights of the inference image data based on the three-dimensional point cloud data or the distance image, and divides the inference image data into the plurality of pieces of inference sub-image data based on the analyzed three-dimensional processed result data. The trained model execution device 10b assigns the evaluation score to each of the pieces of inference sub-image data based on the three-dimensional point cloud data or the distance image, and optimizes the inference calculation processing sequence of the plurality of pieces of inference sub-image data to be subjected to the inference calculation processing based on the information on the evaluation score.

Thus, the trained model execution device 10b can execute the inference calculation processing within a short time without putting the robot 30 on standby for a long time.

Further, the trained model execution device 10b can execute the inference at a high speed by means of an ordinary inexpensive CPU device, and can achieve high production efficiency required for production line at low cost.

In the foregoing, the third embodiment has been described.

### Modification Example 1 of Third Embodiment

The case has been described in which the trained model execution device 10b according to the third embodiment acquires and uses the inference image data and the three-dimensional point cloud data or the distance image from the three-dimensional measurement device 45, and picks the plurality of workpieces 50 loaded in bulk, but this is a non-limiting example. The type, shape, size, color, number, and loading state of the workpieces 50 are not limited.

For example, the trained model execution device 10b may be applicable to a system for executing inference to allow the robot 30 to perform a task of picking the workpieces 50 in a flat loaded state in which the plurality of workpieces 50 are not stacked on each other or in a loaded state in which box-shaped workpieces 50 are loaded (for example, cardboard boxed loaded in a step wise manner).

### Modification Example 2 of Third Embodiment

In the third embodiment, the trained model execution device 10b acquires only the trained model from the database 70, but training image data may also be acquired from the database 70.

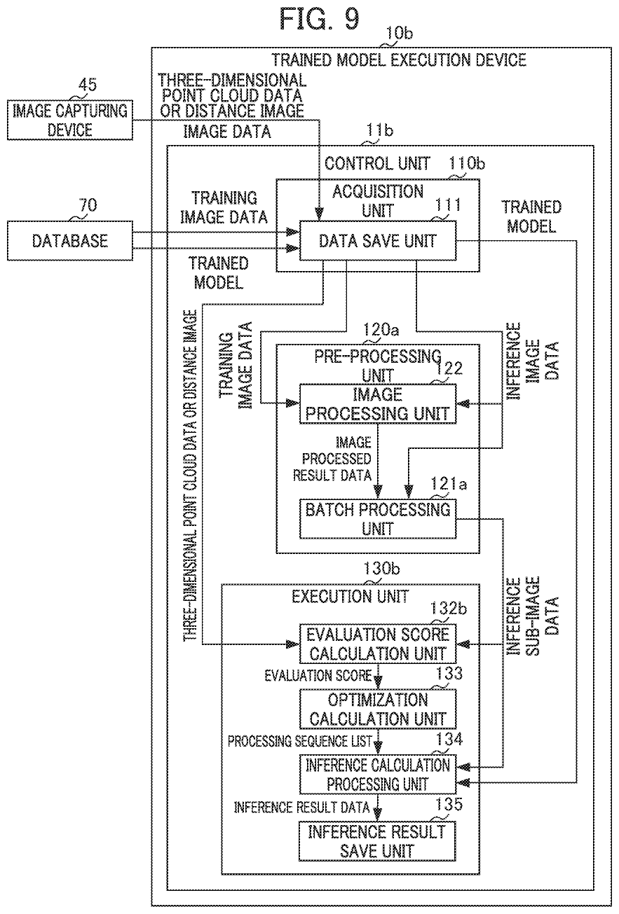

FIG. 9 is a functional block diagram showing a functional configuration example of a trained model execution device 10b according to a modification example of the third embodiment in which the training image data is also acquired. Components having functions similar to those of the trained model execution device 10b in FIG. 7 and the trained model execution device 10a in FIG. 4 are denoted by the same reference numerals, and will not be described in detail.

As shown in FIG. 9, an acquisition unit 110b acquires a trained model and training image data from the database 70.

As in the second embodiment, an image processing unit 122 of the pre-processing unit 120a may be configured to perform image processing on training image data and inference image data, and the batch processing unit 121a may be configured to divide, based on the image processed result, the inference image data into a plurality of pieces of inference sub-image data by batch processing for the inference image data.

An execution unit 130b, an evaluation score calculation unit 132b, an optimization calculation unit 133, an inference calculation processing unit 134, and an inference result save unit 135 have functions equivalent to the evaluation score calculation unit 132b, the optimization calculation unit 133, the inference calculation processing unit 134, and the inference result save unit 135 according to the third embodiment, respectively.

Thus, also when the training image data is acquired from the database 70, the trained model execution device 10b can execute the inference calculation processing within a short time without putting the robot 30 on standby for a long time. Further, the trained model execution device 10b can execute the inference at a high speed by means of an ordinary normal inexpensive CPU device, and can achieve high production efficiency required for production line at low cost.

While the first, second, and third embodiments have been described above, the trained model execution devices 10, 10a, and 10b are not limited to the above-described embodiments, respectively, and include modifications and improvements within a range where the object of the present invention can be achieved.

### Modification Example 1

In the first, second, and third embodiments described above, the trained model execution devices 10, 10a, and 10b have been illustrated as devices different from the robot control device 20, but the robot control device 20 may have a part or all of the functions of each of the trained model execution devices 10, 10a, and 10b.

Alternatively, for example, a server may include some or all of the acquisition unit 110, the pre-processing unit 120, and the execution unit 130 of the trained model execution device 10. Further, for example, a server may include some or all of the acquisition unit 110a, the pre-processing unit 120a, and the execution unit 130a of the trained model execution device 10a. For example, a server may include some or all of the acquisition unit 110b, the pre-processing unit 120b, and the execution unit 130b of the trained model execution device 10b. Furthermore, the functions of the trained model execution devices 10, 10a, and 10b may be implemented using a virtual server function on the cloud.

Furthermore, each of the trained model execution devices 10, 10a, and 10b may be configured as a distributed processing system in which the functions of the trained model execution devices 10, 10a, and 10b are appropriately distributed to a plurality of servers.

### Modification Example 2

For example, the trained model execution device 10 according to the above-described first embodiment is configured to execute the trained model generated by the machine learning based on the image data for the case in which the robot 30 picks the plurality of workpieces 50 loaded in bulk in the container 60, to divide the inference image data into the plurality of pieces of inference sub-image data by way of the batch processing based on the size of the training image data used to perform the machine learning, and to perform the matching processing between the training image data and each of the pieces of inference sub-image data based on the local feature amount extracted from the training image data and each of the plurality of pieces of inference sub-image data. The example has been described in which the trained model execution device 10 assigns the evaluation score to each of the plurality of pieces of inference sub-image data according to the matching degree, optimizes the inference calculation processing sequence of the plurality of pieces of inference sub-image data based on the evaluation scores, performs the inference calculation processing for the plurality of pieces of inference sub-image data according to the optimized inference calculation processing sequence, and calculates the picking position candidate for the workpiece 50 to be picked by the robot 30. However, the trained model execution device 10 is not limited to the case of executing the trained model generated by the machine learning based on the image data for the case in which the robot 30 picks the plurality of workpieces 50 loaded in bulk in the container 60. The type, shape, size, color, number, and loading state of the workpieces 50 are not limited.

For example, the trained model execution device 10 may be applicable to a system for executing inference to allow the robot 30 to perform a task of picking the workpieces 50 in a flat loaded state in which the plurality of workpieces 50 are not stacked on each other or in a loaded state in which box-shaped workpieces 50 are loaded (for example, cardboard boxed loaded in a step wise manner).

For example, the trained model execution device 10, may be applied to a system that makes an inference for executing an arbitrary task based on voice data obtained during a conversation or a meeting of a plurality of persons, instead of the system in which the robot 30 picks the plurality of workpieces 50 loaded in bulk in the container 60. In this case, the trained model execution device 10 may replace the image data with the voice data, divide voice data for inference (hereinafter, referred to also as “inference voice data”) into a plurality of pieces of inference sub-voice data based on voice data for training (hereinafter, also referred to as “training voice data”) by way of batch processing, and perform matching processing between the training voice data and each of the pieces of inference sub-voice data based on feature amounts extracted from training voice data and the plurality of pieces of inference sub-voice data. Then, using a method similar to that of the first embodiment, the trained model execution device 10 may assign an evaluation score to each of the plurality of pieces of inference sub-voice data in accordance with the matching degree, optimize the inference calculation processing sequence of the plurality of pieces of inference sub-voice data based on the evaluation scores, perform the inference calculation processing for the plurality of pieces of inference sub-voice data according to the optimized inference calculation processing sequence, and find conversation contents (for example, contents related to specific target keywords such as “inu (dog)”, “neko (cat)”, and “tenki (weather)”), which is training voice data defined from mass voice data, within a short inference calculation processing time. Thereby, for example, in a case of a system for inferring and recognizing conversation contents based on the voice data obtained during the conversation or meeting of the plurality of persons, the trained model execution device 10 can shorten the inference calculation processing time by avoiding useless inference calculation processing for the inference sub-voice data including a zone (in a case of converting the voice data into cells, a plurality of cell groups, which may be referred to as a “cell group”) that does not include prescribed voice data such as voice data of a person.

Alternatively, for example, the trained model execution device 10 is applicable, as a system that makes an inference for executing an arbitrary task based on character data, to a case of executing the trained model generated by the machine learning based on the character data, instead of the system in which the robot 30 picks the plurality of workpieces 50 loaded in bulk in the container 60. Specifically, while the image data is replaced with the character data, the trained model execution device 10 may divide, using a method similar to that of the first embodiment, character data for inference (hereinafter, also referred to as “inference character data”) into a plurality of pieces of inference sub-character data based on character data for training (hereinafter, also referred to as “training character data”) by way of batch processing, and perform matching processing between the training character data and each of the pieces of inference sub-character data based on the feature amounts extracted from training character data and the plurality of pieces of inference sub-character data. Then, the trained model execution device 10 may assign an evaluation score to each of the plurality of pieces of inference sub-character data according to the matching degree, optimize the inference calculation processing sequence of the plurality of pieces of inference sub-character data based on the evaluation scores, perform the inference calculation processing for the plurality of pieces of inference sub-character data according to the optimized inference calculation processing sequence, and find training character data (for example, contents related to specific target keywords of “year”, “month”, and “day”), which is prescribed from mass character data, within a short inference calculation processing time. Thereby, for example, in a case of specifying a predetermined failure (for example, the number of failures and failure time and place of a reducer) based on failure history data (character data) of the robot 30, the trained model execution device 10 can shorten the inference calculation processing time by avoiding useless inference calculation processing for the inference sub-character data including a zone (in a case of converting the character data into cells, a plurality of cell groups, which may be referred to as a “cell group”) that does not include the prescribed character data (for example, a target keyword “reducer”).

Hereinafter, a description will be given in more detail with respect to a case (a) where the inference data is voice data and a case (b) where the inference data is character data.

(a) Case where Inference Data is Voice Data

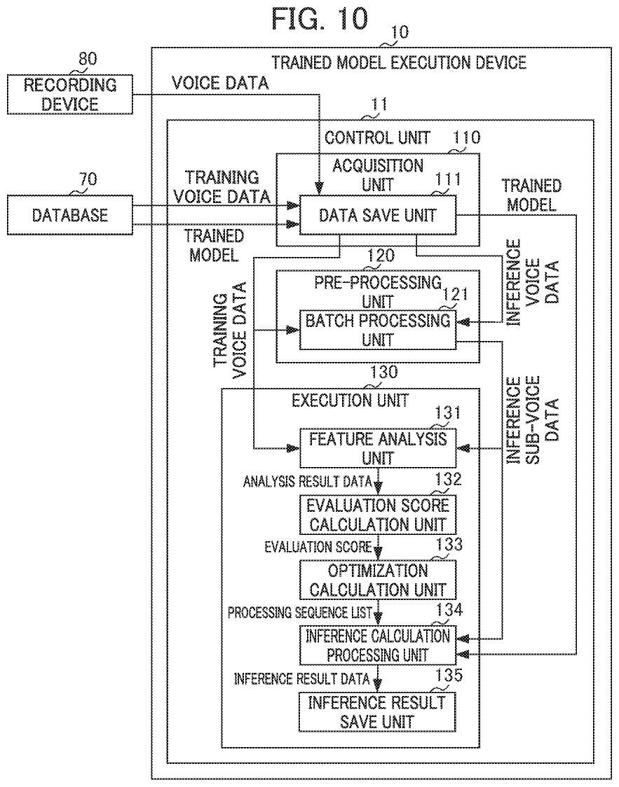

FIG. 10 is a functional block diagram showing a functional configuration example of a trained model execution device 10 in a case where the inference data is voice data. Components having functions similar to those of the trained model execution device 10 in FIG. 2 are denoted by the same reference numerals, and will not be described in detail.

For example, a trained model in this case receives an input of pieces of inference sub-voice data, and outputs information indicating, for example, a ratio between data including a prescribed conversion content (for example, specific target keywords of “inu (dog)”, “neko (cat)”, and “tenki (weather)”) attached as a teaching label onto training voice data and data devoid of the prescribed conversion content.

An acquisition unit 110 may acquire voice data as inference data from a recording device 80 such as a combination of a microphone and a computer, a computer having a built-in microphone, a smartphone, a tablet terminal, or a video camera.

As in the case of the inference image data in FIG. 2, a batch processing unit 121 of a pre-processing unit 120 may divide inference voice data by way of batch processing using a size of training voice data as a minimum size, and generate and output a plurality of pieces of inference sub-voice data.

As in the case of the inference image data in FIG. 2, an execution unit 130 may be configured to assign an evaluation score to each of the plurality of inference sub-voice data divided by the batch processing in the pre-processing unit 120 based on a matching degree with the training voice data, and optimize the inference calculation processing sequence of the plurality of pieces of inference sub-voice data based on priority determined depending on a magnitude of the assigned evaluation score.

Specifically, a feature analysis unit 131 performs, for example, feature analysis (for example, frequency feature analysis) on the training voice data, and extracts a feature amount (hereinafter, also referred to as a “frequency feature analysis result”) B of voice data of the prescribed conversation contents (for example, specific target keywords of “inu (dog)”, “neko (cat)”, and “tenki (weather)”) attached as teaching labels. Further, the feature analysis unit 131 also performs frequency feature analysis on m pieces of inference sub-voice data AUD1, AUD2, . . . , and AUDm divided by the batch processing in the pre-processing unit 120, and extracts a frequency feature analysis result (m being an integer of 2 or more). For example, it is assumed that the feature analysis unit 131 extracts frequency feature analysis results B11 and B12 from the inference sub-voice data AUD1, extracts frequency feature analysis results B21, B22, and B23 from the inference sub-voice data AUD2, and extracts frequency feature analysis results B31, B32, B33, and B34 from the inference sub-voice data AUD3. The feature analysis unit 131 performs matching processing between each of the extracted frequency feature analysis results B11, B12, B21, B22, B23, B31, B32, B33, and B34 and the frequency feature analysis result B of the training voice data, and outputs analysis result data of the matching processing to the evaluation score calculation unit 132.

The evaluation score calculation unit 132 receives the analysis result data output by the feature analysis unit 131, and assigns a high evaluation score (for example, 70 points) to the inference sub-voice data AUD2 when the inference sub-voice data AUD2 includes the frequency feature analysis result (for example, B22) with a high matching degree, for example. Further, the evaluation score calculation unit 132 assigns a higher evaluation score (for example, 80 points) to the inference sub-voice data AUD3 when the one piece of inference sub-voice data AUD3 includes the plurality of frequency feature analysis results (for example, B32 and B34) with a high matching degree, for example. The evaluation score calculation unit 132 outputs the evaluation scores assigned in this way to the optimization calculation unit 133.

Based on information on the evaluation score output by the evaluation score calculation unit 132, the optimization calculation unit 133 gives high priority to the inference sub-voice data with the high evaluation score such that the inference calculation processing is preferentially performed in descending order of the evaluation score. The optimization calculation unit 133 optimizes the inference calculation processing sequence of the m pieces of inference sub-voice data divided by the batch processing in the pre-processing unit 120, and generates a processing sequence list indicating the optimized inference calculation processing sequence. The optimization calculation unit 133 outputs the generated processing sequence list to the inference calculation processing unit 134.

The optimization calculation unit 133 may delete inference sub-voice data having a low evaluation score from the processing sequence list such that the inference sub-voice data is not subjected to the inference calculation processing.

The inference calculation processing unit 134 performs inference calculation processing based on the information on the processing sequence list received from the optimization calculation unit 133, the m pieces of inference sub-voice data divided by the batch processing in the pre-processing unit 120, and the trained model. The inference calculation processing unit 134 saves the inference result data of the inference calculation processing in the inference result save unit 135.

Since there is a high possibility that the inference sub-voice data with a high evaluation score includes a specific target keyword attached to the teaching label of the target, the trained model execution device 10 preferentially performs the inference calculation processing on the inference sub-voice data in descending order of the evaluation score. Thereby, the trained model execution device 10 can quickly find out the prescribed conversation content, finish the inference calculation processing early, and thus shorten the inference calculation processing time. In other words, since there is a low possibility that inference sub-voice data with a low evaluation score includes a target keyword, the trained model execution device 10 does not perform the inference calculation processing on the inference sub-voice data with the low evaluation score, thereby useless inference calculation processing time can be eliminated. That is, the trained model execution device 10 can find out the prescribed conversation content from mass voice data within a short inference calculation processing time.

(b) Case where Inference Data is Character Data

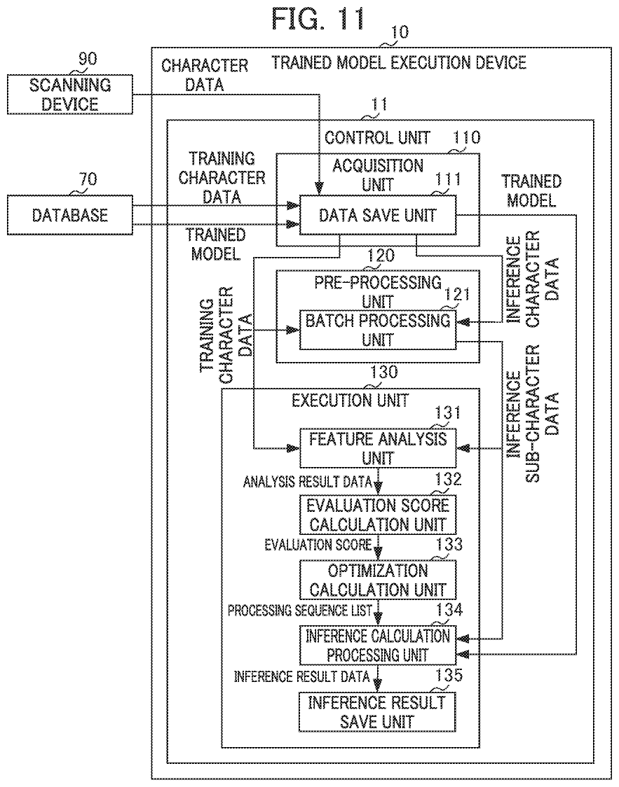

FIG. 11 is a functional block diagram showing a functional configuration example of a trained model execution device 10 in a case where the inference data is the character data. Components having functions similar to those of the trained model execution device 10 in FIG. 2 are denoted by the same reference numerals, and will not be described in detail.

For example, a trained model in this case receives an input of pieces of inference sub-character data, and outputs information indicating, for example, a ratio between data including a prescribed character data (for example, specific target keywords of “year”, “month”, and “day” indicating a time) attached as a teaching label onto training character data and data devoid of the prescribed character data.

An acquisition unit 110 may acquire character data as inference data from a scanning device 90 such as a scanner for acquiring an image of character data recorded on paper, a camera, a printer with a scanning function, or a touch panel capable of handwriting input.

As in the case of the inference image data in FIG. 2, a batch processing unit 121 of a pre-processing unit 120 may divide inference character data by way of batch processing using a size of training character data as a minimum size, and generate and output a plurality of pieces of inference sub-character data.

As in the case of the inference image data in FIG. 2, an execution unit 130 may be configured to assign an evaluation score to each of the plurality of inference sub-character data divided by the batch processing in the pre-processing unit 120 based on a matching degree with the training character data, and optimize the inference calculation processing sequence of the plurality of pieces of inference sub-character data based on priority determined depending on a magnitude of the assigned evaluation score.

Specifically, the feature analysis unit 131 performs, for example, feature analysis (for example, feature analysis of character aspect ratio, symmetry with respect to an X-axis, symmetry with respect to a Y-axis, and the like) on the training character data, and extracts a feature amount (hereinafter, also referred to as a “feature analysis result”) C of the prescribed character data (for example, specific target keywords of “year”, “month”, and “day” indicating a time) attached as a teaching label. Further, the feature analysis unit 131 also performs feature analysis on k pieces of inference sub-character data MOJI1, MOJI2, . . . , and MOJIk divided by the batch processing in the pre-processing unit 120, and extracts a feature analysis result (k being an integer of 2 or more). For example, it is assumed that the feature analysis unit 131 extracts feature analysis results C11 and C12 from the inference sub-character data MOJI1, extracts feature analysis results C21, C22, and C23 from the inference sub-character data MOJI2, and extracts feature analysis results C31, C32, C33, and C34 from the inference sub-character data MOJI3. The feature analysis unit 131 performs matching processing between each of the extracted feature analysis results C11, C12, C21, C22, C23, C31, C32, C33, and C34 and the feature analysis result C of the training character data, and outputs analysis result data of the matching processing to the evaluation score calculation unit 132.

The evaluation score calculation unit 132 receives the analysis result data output by the feature analysis unit 131, and assigns a high evaluation score (for example, 70 points) to the inference sub-character data MOJI2 when the inference sub-character data MOJI2 includes the feature analysis result (for example, C22) with a high matching degree, for example. Further, the evaluation score calculation unit 132 assigns a higher evaluation score (for example, 80 points) to the inference sub-character data MOJI3 when one inference sub-character data MOJI3 includes the plurality of feature analysis results (for example, C32 and C34) with a high matching degree, for example. The evaluation score calculation unit 132 outputs the evaluation scores assigned in this way to the optimization calculation unit 133.

Based on information on the evaluation score output by the evaluation score calculation unit 132, the optimization calculation unit 133 gives high priority to the inference sub-character data with the high evaluation score such that the inference calculation processing is preferentially performed in descending order of the evaluation score. The optimization calculation unit 133 optimizes the inference calculation processing sequence of the k pieces of inference sub-character data divided by the batch processing in the pre-processing unit 120, and generates a processing sequence list indicating the optimized inference calculation processing sequence. The optimization calculation unit 133 outputs the generated processing sequence list to the inference calculation processing unit 134.

The optimization calculation unit 133 may delete inference sub-character data having a low evaluation score from the processing sequence list such that the inference sub-character data is not subjected to the inference calculation processing.

The inference calculation processing unit 134 performs inference calculation processing based on the information on the processing sequence list received from the optimization calculation unit 133, the k pieces of inference sub-character data divided by the batch processing in the pre-processing unit 120, and the trained model. The inference calculation processing unit 134 saves the inference result data of the inference calculation processing in the inference result save unit 135.

Since there is a high possibility that the inference sub-character data with a high evaluation score includes a specific target keyword attached as the teaching label of the target, the trained model execution device 10 preferentially performs the inference calculation processing on the inference sub-character data in descending order of the evaluation score. Thereby, the trained model execution device 10 can quickly find out the character data such as a “failure of the robot 30 that occurred on XX month, XX day, XXXX year” based on the prescribed character data (for example, specific target keywords of “year”, “month”, and “day” indicating a time) attached as a teaching label, and thus shorten the inference calculation processing time. In other words, since there is a low possibility that inference sub-character data with a low evaluation score includes a target keyword, the trained model execution device 10 does not perform the inference calculation processing on the inference sub-character data with the low evaluation score, thereby useless inference calculation processing time can be eliminated. That is, the trained model execution device 10 can find out the prescribed character data from mass character data within a short inference calculation processing time.

### Modification Example 3

For example, the trained model execution device 10a according to the above-described second embodiment executes the trained model generated by the machine learning based on the image data for the case in which the robot 30 picks the plurality of workpieces 50 loaded in bulk in the container 60, acquires the inference image data from the image capturing device 40 and the trained model from the database 70, performs the image processing on the acquired inference image data, and divides, based on the feature points extracted from the inference image data, the inference image data into the inference sub-image data in which the feature points are concentrated and the inference sub-image data having few or no feature point. The example has been described in which the trained model execution device 10a assigns the evaluation score to each of the pieces of inference sub-image data based on the number of feature points of the inference sub-image data, optimizes the inference calculation processing sequence of the plurality of pieces of inference sub-image data based on the evaluation scores, performs the inference calculation processing for the plurality of pieces of inference sub-image data according to the optimized inference calculation processing sequence, and calculates the picking position candidate for the workpiece 50 to be picked by the robot 30. However, the trained model execution device 10a is not limited to the case of executing the trained model generated by the machine learning based on the image data for the case in which the robot 30 picks the plurality of workpieces 50 loaded in bulk in the container 60. The type, shape, size, color, number, and loading state of the workpieces 50 are not limited.

For example, the trained model execution device 10a may be applicable to a system for executing inference to allow the robot 30 to perform a task of picking the workpieces 50 in a flat loaded state in which the plurality of workpieces 50 are not stacked on each other or in a loaded state in which box-shaped workpieces 50 are loaded (for example, cardboard boxed loaded in a step wise manner).

Further, as in Modification Example 2, for example, the trained model execution device 10a may be applicable to a system that makes an inference for executing an arbitrary task based on voice data recorded during a conversation or a meeting of a plurality of persons. For example, the trained model execution device 10a may acquire the voice data for inference (hereinafter, also referred to as “inference voice data”) from a recording device such as a microphone and acquire the trained model from the database 70, perform the feature analysis (for example, frequency analysis) on the acquired inference voice data, divide it into the plurality of pieces of inference sub-voice data based on the frequency analysis result extracted from the inference voice data, and assigns an evaluation score to each of the pieces of inference sub-voice data. Then, the trained model execution device 10a may optimize the inference calculation processing sequence of the plurality of pieces of inference sub-voice data based on the evaluation scores, perform the inference calculation processing for the plurality of pieces of inference sub-voice data according to the optimized inference calculation processing sequence, and find conversation contents (for example, person's voice data of “inu (dog)”, “neko (cat)”, and “tenki (weather)”), which are defined from mass voice data, within a short inference calculation processing time. Thereby, for example, in a case of specifying the prescribed conversation contents, the trained model execution device 10a can shorten the inference calculation processing time by avoiding useless inference calculation processing for the inference sub-voice data including a zone (cell group) that does not include prescribed voice data, that is, voice of a person.

Alternatively, for example, the trained model execution device 10a is applicable, as a system that makes an inference for executing an arbitrary task based on character data, to a case of executing the trained model generated by the machine learning based on the character data, instead of the system in which the robot 30 picks the plurality of workpieces 50 loaded in bulk in the container 60. Specifically, while the image data is replaced with the character data, the trained model execution device 10a may acquire character data for inference (hereinafter, also referred to as “inference character data”) from a scanning device such as a scanner using a method similar to that of the second embodiment, and acquire a trained model from the database 70, perform feature analysis on the acquired inference character data, divide the character inference data into a plurality of pieces of inference sub-character data based on the feature analysis result extracted from the inference character data, and assign an evaluation score to each of the pieces of inference sub-character data. Then, the trained model execution device 10a may optimize the inference calculation processing sequence of the plurality of pieces of inference sub-character data based on the evaluation scores, perform the inference calculation processing for the plurality of pieces of inference sub-character data according to the optimized inference calculation processing sequence, and find character data (for example, “metropolis”, “prefecture”, “city”, “county”, and “village”), which are defined from mass character data, within a short inference calculation processing time. Thereby, for example, in a case of specifying the destinations of mails and sorting the mails according to the destinations, the trained model execution device 10a does not perform the inference calculation processing on the inference sub-character data including a zone (cell group) that does not include prescribed character data, that is, “metropolis” to “village”, thereby avoiding useless inference calculation processing and shortening the inference calculation processing time.

Hereinafter, a description will be given in more detail with respect to a case (a) where the inference data is voice data and a case (b) where the inference data is character data.

(a) Case where Inference Data is Voice Data

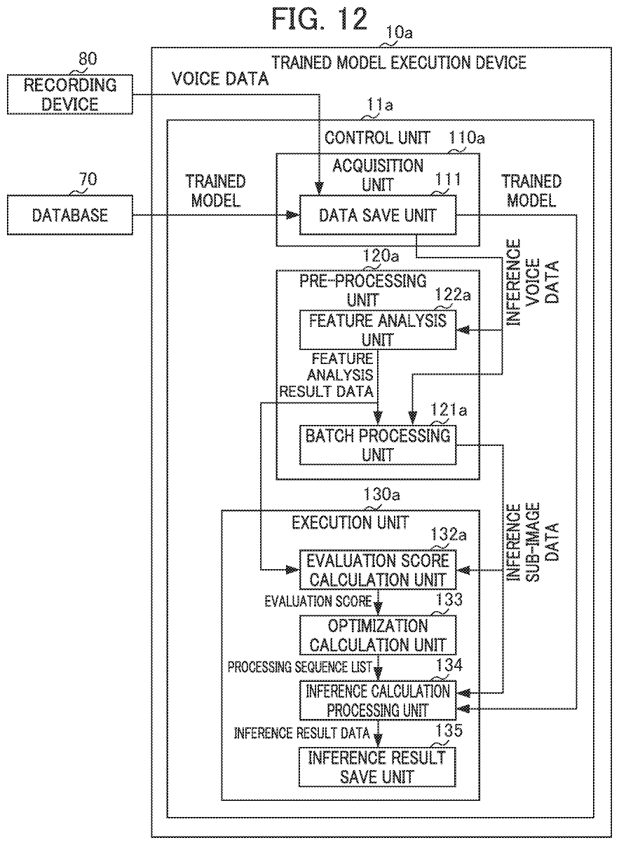

FIG. 12 is a functional block diagram showing a functional configuration example of a trained model execution device 10a in a case where the inference data is voice data. Components having functions similar to those of the trained model execution device 10a in FIG. 4 are denoted by the same reference numerals, and will not be described in detail.

For example, a trained model in this case receives an input of each of pieces of inference sub-voice data, and outputs information indicating, for example a ratio between data including a prescribed conversion content (for example, specific target keywords of “inu (dog)”, “neko (cat)”, and “tenki (weather)”) and data devoid of the prescribed conversion content.

An acquisition unit 110a may acquire voice data as inference data from a recording device 80 such as a combination of a microphone and a computer, a computer having a built-in microphone, a smartphone, a tablet terminal, or a video camera.

A pre-processing unit 120a may be configured to perform feature analysis on inference voice data, and divide the inference voice data into a plurality of pieces of inference sub-voice data by way of batch processing based on feature analysis result data.

Specifically, a feature analysis unit 122a of the pre-processing unit 120a corresponds to the feature analysis unit 131 in FIG. 10, and may perform feature analysis (for example, frequency feature analysis) on inference voice data and output feature analysis result data. As to the feature analysis result data (frequency analysis result), a zone of the inference voice data in which the amplitude is too low can be regarded as data that does not include the prescribed conversation contents (for example, “inu (dog)”) of the voice of the person to be specified, but includes only surrounding environment noise at the time of recording. In this case, if the inference calculation processing is performed on the voice data of the zone and an attempt is made to find the prescribed conversation contents of the voice of the person to be specified, the inference calculation processing time is wasted. Further, a zone of the inference voice data in which the amplitude is too high is, for example, a portion of the voice data that exceeds a recordable range of the recording device 80, and may be missing data in which the voice data has not been successfully acquired. If the inference calculation processing is performed on the voice data in such a zone, it is highly probable that inference (recognition) will not be successful.

A batch processing unit 121a of the pre-processing unit 120a may divide the inference voice data into a plurality of pieces of inference sub-voice data that are not to be subjected to the inference calculation processing by cutting out the zones of the voice data as described above.

In addition, when a waveform appears periodically in the frequency analysis result of the inference voice data, it can be assumed that the same person continues to repeat the same word within a certain period of time, and the batch processing unit 121a may divide the inference voice data into a plurality of pieces of inference sub-voice data by way of batch processing, with reference to the waveform appearing periodically a cut position.

An execution unit 130a may be configured to optimize the inference calculation processing sequence of the plurality of pieces of inference sub-voice data based on the feature analysis result data output by the feature analysis unit 122a of the pre-processing unit 120a.

For example, when the batch processing unit 121a generates the plurality of pieces of inference sub-voice data based on the feature analysis result, an evaluation score calculation unit 132a may assign a low evaluation score to a plurality of pieces of inference sub-voice data of which amplitude is too low or too high, for example, based on the frequency analysis result, and the optimization calculation unit 133 may lower the priority for the inference calculation processing so that the inference calculation processing will not be performed.

Thus, it is possible to shorten the inference calculation processing time for the inference voice data and quickly find a specific conversation content in a case of searching for a specific conversation content from the inference voice data of a long conversation, by eliminating useless inference calculation processing on the inference sub-voice data including environmental noise without voice of the person and on the inference sub-voice data that exceeds the recordable range of the recording device 80 and has not been successfully acquired. In other words, for example, when specifying the prescribed conversation content, the trained model execution device 10a can avoid the useless inference calculation processing for the inference sub-voice data including the zone (cell group) in which the prescribed voice data (that is, voice of the person) is not included and thus shorten the inference calculation processing time.

(b) Case where Inference Data is Character Data

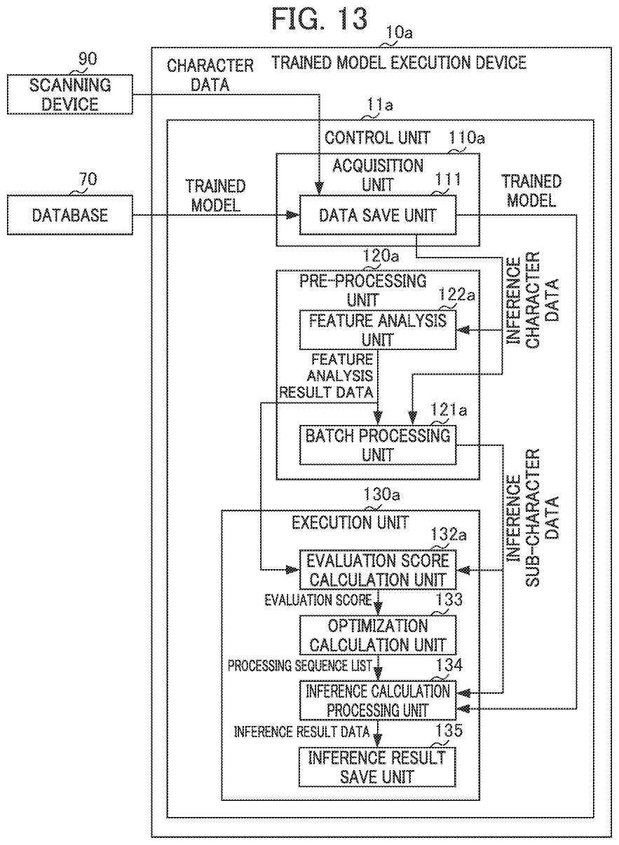

FIG. 13 is a functional block diagram showing a functional configuration example of a trained model execution device 10a in a case where the inference data is the character data. Components having functions similar to those of the trained model execution device 10a in FIG. 4 are denoted by the same reference numerals, and will not be described in detail.

For example, the trained model in this case receives an input of inference sub-character data including the destinations of mails, and outputs information indicating, for example, a ratio between data including a prescribed character data (for example, specific target keywords of “metropolis” to “village” for specifying the addresses) and data devoid of the prescribed character data.

An acquisition unit 110a may acquire character data as inference data from a scanning device 90 such as a scanner for acquiring an image of character data recorded on paper, a camera, a printer with a scanning function, or a touch panel capable of handwriting input.

A pre-processing unit 120a may be configured to perform feature analysis on inference character data, and divide the inference character data into a plurality of pieces of inference sub-character data by way of batch processing based on feature analysis result data.

Specifically, a feature analysis unit 122a of the pre-processing unit 120a corresponds to the feature analysis unit 131 in FIG. 11, and may perform feature analysis on inference character data and output feature analysis result data. For example, a task of performing character recognition of handwritten addresses and automatically sorting mails according to the destinations of the mails will be described as an example. The acquisition unit 110a includes a data save unit 111, uses a scanning device 90 to register character data as image data obtained by scanning an area in which the destination of the mail is written, and further saves it in a recording medium such as a HDD of a PC (not shown). For example, the feature analysis unit 122a converts the entire zone of an image data including a series of handwritten characters acquired in this way into cells. The feature analysis unit 122a digitizes the presence/absence of characters in each small cell, attaches a label of “1” to cells with characters in the zone, and attaches a label of “0” to cells without characters in the zone. In this way, the feature analysis unit 122a uses a label feature map extracted by attaching the labels “0” and “1” to the entire zone of the character image data, and thereby recognizes a zone having the labels “0” continuously attached thereto as a space between the characters to and delimit the characters. Further, the feature analysis unit 122a can perform matching between the separated independent characters and the printed form “metropolis”, “prefecture”, “city”, “county”, and “village”, and can specify, from a series of handwritten character data, a zone (cell group) in which the characters of “metropolis”, “prefecture”, “city”, “county”, and “village” exist. The feature analysis unit 122a outputs, as feature analysis result data, the label feature map and information on the zones containing the specific characters (“metropolis” to “village”) obtained in this way.

A batch processing unit 121a of the pre-processing unit 120a can receive the feature analysis result data (label feature map and existence zone information of the information on the zones containing the specific characters (“metropolis” to “village”) output by the feature analysis unit 122a, and divide the inference character data by way of batch processing, using the zones (cell group) containing the specific characters “metropolis” to “village” exist as a delimiters, to thereby generate and output a plurality of pieces of inference sub-character data.

An execution unit 130a may be configured to optimize the inference calculation processing sequence of the plurality of pieces of inference sub-character data based on the feature analysis result data output by the feature analysis unit 122a of the pre-processing unit 120a.

For example, in the case where the plurality of pieces of inference sub-character data are generated by the batch processing unit 121a of the pre-processing unit 120a, if inference calculation processing is performed on the inference sub-character data including a zone (cell group) containing no characters or a zone (cell group) not containing the specific characters “metropolis” to “village”, such inference calculation processing will result in useless processing that does not serve for the purpose of specifying where to send the mail. Therefore, an evaluation score calculation unit 132a may assign a low evaluation score to the inference sub-character data including a zone (cell group) containing no characters or a zone (cell group) not containing the specific characters “metropolis” to “village”, and may lower the priority of the inference calculation processing so that the inference calculation processing will not be performed. Further, the evaluation score calculation unit 132a assigns a high evaluation score to inference sub-character data including a zone (cell group) that contains the specific characters “metropolis” to “village”, and preferentially performs the inference calculation processing on the data assigned with the high evaluation scores, whereby the destination of the mail can be specified quickly, and the inference calculation processing time for the automatic sorting task of the mails can be shortened.

### Modification Example 4

For example, while the trained model execution device 10a according to the second embodiment acquires only the trained model from the database 70, the trained model execution device 10a may further acquire training image data from the database 70.

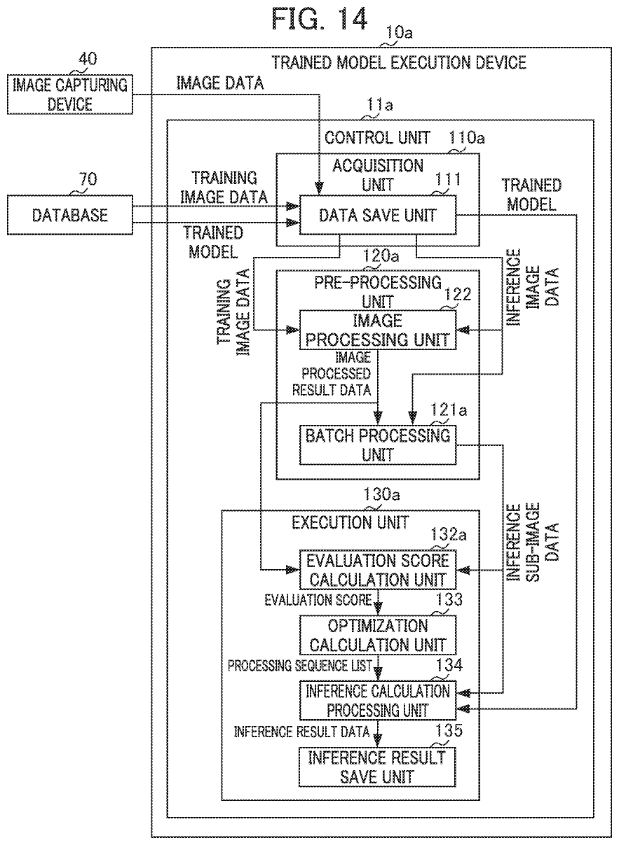

FIG. 14 is a functional block diagram showing a functional configuration example of a trained model execution device 10a in a case of also acquiring training image data. Components having functions similar to those of the trained model execution device 10a in FIG. 4 are denoted by the same reference numerals, and will not be described in detail.

As shown in FIG. 14, an acquisition unit 110a acquires a trained model and training image data from a database 70.

A pre-processing unit 120a may be configured to perform image processing on the training image data and inference image data, perform batch processing on the inference image data based on the image processed result, and divide the inference image data into a plurality of pieces of inference sub-image data.

Specifically, an image processing unit 122 of the pre-processing unit 120a functions as the feature analysis unit 131 of the execution unit 130 in FIG. 2, and performs image processing on each of a neighboring image zone, which includes a picking position indicated by a label attached to the training image data, and the inference image data to extract a specific local feature amount, for example. The image processing unit 122 may perform matching between the local feature amount of the neighboring image at the labeled teaching position on the extracted training image data and each of local feature amounts at a plurality of locations on the inference image data, calculate a matching degree, and output the matching degree as image processed result data.

A batch processing unit 121a of the pre-processing unit 120a divides the inference image data such that a local image zone on the inference image data having a high matching degree with the neighboring image near the teaching position on the training image data is defined as one independent inference sub-image data. In addition, the batch processing unit 121a divides the inference image data such that a local image zone on the inference image data having a low matching degree with the neighboring image near the teaching position on the training image data is defined as one independent inference sub-image data.

In other words, the batch processing unit 121a may divide and output the inference image data such that the local image zone in which many workpieces 50 to be picked are likely to be present is defined as one piece of inference sub-image data and that the local image zone containing few or no workpiece 50 to be picked is defined as one piece of inference sub-image data.

Specifically, at the stage of the batch processing for the inference image data, the inference sub-image data in which the workpieces 50 are highly likely to be found and which should be preferentially subjected to the inference calculation processing is distinguished from the inference sub-image data in which the target workpiece 50 cannot be found in spite of the inference calculation, and thus, the execution unit 130a can optimize the inference calculation processing sequence efficiently and smoothly.

The case has been described above in which the plurality of workpieces 50 loaded in bulk are picked, but this is a non-limiting example. The type, shape, size, color, number, and loading state of the workpieces 50 are not limited. For example, the trained model execution device 10a may be applicable to a system for executing inference to allow the robot 30 to perform a task of picking the workpieces 50 in a flat loaded state in which the plurality of workpieces 50 are not stacked on each other or in a loaded state in which box-shaped workpieces 50 are loaded (for example, cardboard boxed loaded in a step wise manner).

While the inference data is the inference image data, it may be inference voice data or inference character data, and when the image processing unit 122 is replaced with the feature analysis unit 131, it can be applicable to the trained model execution device 10a shown in FIG. 14.

The respective functions included in the trained model execution device 10 according to the first embodiment, the trained model execution device 10a according to the second embodiment, and the trained model execution device 10b according to the third embodiment can be implemented by hardware, software, or a combination of the hardware and the software. Here, the implementation by the software means that implementation by a computer reading and executing a program.

the program may be stored and supplied to a computer using various types of non-transitory computer readable media. The non-transitory computer-readable media include various types of tangible storage media. Examples of non-transitory computer-readable media include magnetic storage media (such as flexible disks, magnetic tapes, hard disk drives, etc.), optical magnetic storage media (for example, magneto-optical disks), a CD-ROM (read only memory), CD-R, CD-R/W, and semiconductor memories (such as mask ROM, PROM (programmable ROM), EPROM (erasable PROM), flash ROM, RAM (random access memory)). The programs may be supplied to a computer using any type of transitory computer-readable media. Examples of transitory computer readable media include electric signals, optical signals, and electromagnetic waves. Transitory computer readable media can supply programs to a computer via a wired communication line (for example, electric wires, and optical fibers) or a wireless communication line.

It should be noted that steps of describing the programs to be recorded on the recording medium include not only processes that are executed chronologically in order, but also processes that are executed in parallel or individually, even when not being necessarily processed chronologically.

In other words, the inference calculation processing device and the inference calculation processing method according to the present disclosure can take various embodiments having the following configurations.

(1) The trained model execution device 10 as the inference calculation processing device according to the present disclosure is an inference calculation processing device that inputs inference data to a trained model and executes inference calculation processing for the inference data. The inference calculation processing device includes: the acquisition unit 110 configured to acquire the inference data and the trained model; the pre-processing unit 120 configured to divide the inference data acquired by the acquisition unit 110 into a plurality of pieces of inference sub-data by way of batch processing; and the execution unit 130 configured to optimize an inference calculation processing sequence of the plurality of pieces of inference sub-data divided by the pre-processing unit 120 using the batch processing, and execute the inference calculation processing for the inference data according to the optimized inference calculation processing sequence, based on each of at least one of the plurality of pieces of inference sub-data and the trained model.

The trained model execution device 10 id capable of executing the inference calculation processing within a short time without putting the robot 30 on standby.

(2) In the trained model execution device 10 as set forth in (1), the acquisition unit 110 may acquire training data that has been used in machine learning to generate the trained model.

Thus, the trained model execution device 10 can divide the inference data based on the size of the training data.

(3) In the trained model execution device 10 as set forth in (2), the pre-processing unit 120 may divide the inference data into the plurality of pieces of inference sub-data using the batch processing based on the size of the training data.

Thus, the trained model execution device 10 can prevent a situation in which the divided inference sub-image is too small in size to include the necessary image features, and subsequent inference calculation processing using the trained model does not work properly.

(4) In the trained model execution device 10 as set forth in (2) or (3), the execution unit 130 may perform matching processing between the training data and each of the plurality of pieces of inference sub-data, assign the evaluation score according to the matching degree to each of the plurality of pieces of inference sub-data, and optimize the inference calculation processing sequence of the plurality of pieces of inference sub-data based on the priority depending on the assigned evaluation score.

Thus, for example, when the plurality of workpieces 50 loaded in bulk in the container 60 are picked, the trained model execution device 10 can eliminate useless inference calculation processing in which the candidates for the workpieces 50 to be picked cannot be found in spite of the inference calculation processing on the inference sub-data with a low matching degree, and shorten the inference calculation processing time. Further, the trained model execution device 10 can preferentially perform the inference calculation processing on the inference sub-data with a high matching degree, thereby quickly finding the number of candidates for the workpieces 50 specified in advance, finishing the inference calculation processing early, and shortening the inference calculation processing time.

(5) In the trained model execution device 10 as set forth in any one of (1) to (4), the acquisition unit 110 may acquire the image data as the inference data.

Thus, the trained model execution device 10 can find out the workpiece 50 that can be picked by the robot 30.

(6) In the trained model execution device 10a as set forth in (5), the pre-processing unit 120a may perform the image processing for extracting the feature amount of the image data acquired as the inference data.

Thus, the trained model execution device 10a can optimally divide the inference image data into the plurality of pieces of inference sub-image data without acquiring the training data.

(7) In the trained model execution device 10a as set forth in (6), the pre-processing unit 120a may divide the inference data into the plurality of pieces of inference sub-data by way of the batch processing based on the result of the image processing.

Thus, the trained model execution device 10a can optimally divide the inference image data into the plurality of pieces of inference sub-image data without acquiring the training data.

(8) In the trained model execution device 10a as set forth in (6) or (7), the execution unit 130a may assign the evaluation score to each of the plurality of pieces of inference sub-data based on the result of the image processing, and optimize the inference calculation processing sequence of the plurality of pieces of inference sub-data based on the priority depending on the assigned evaluation score.

Thus, for example, the trained model execution device 10a can eliminate useless inference calculation processing in which the candidates for the workpieces 50 to be picked cannot be found in spite of the inference calculation processing performed on the inference sub-data that is unlikely to include the workpieces 50 to be picked, and shorten the inference calculation processing time. Further, the trained model execution device 10a can preferentially perform the inference calculation processing on the inference sub-data that is highly likely to include the workpieces 50 to be picked, thereby quickly finding the number of candidates for the workpieces 50 specified in advance, finishing the inference calculation processing early, and shortening the inference calculation processing time.

(9) In the trained model execution device 10 as set forth in any one of (1) to (4), the voice data may be acquired as the inference data.

Thus, the trained model execution device 10 can find the conversation contents, which are defined from mass voice data, within a short inference calculation processing time.

(10) In the trained model execution device 10a as set forth in (9), the pre-processing unit 120a may perform the feature analysis for extracting the feature amount of the voice data acquired as the inference data.

Thus, the trained model execution device 10a can optimally divide the inference voice data into the plurality of pieces of inference sub-voice data without acquiring the training data.

(11) In the trained model execution device 10a as set forth in (10), the pre-processing unit 120a may divide the inference data into the plurality of pieces of inference sub-data by way of the batch processing based on the result of the feature analysis.

Thus, the trained model execution device 10a can optimally divide the inference voice data into the plurality of pieces of inference sub-voice data without acquiring the training data.

(12) In the trained model execution device 10a as set forth in (10) or (11), the execution unit 130a may assign the evaluation score to each of the plurality of pieces of inference sub-data based on the result of the feature analysis, and optimize the inference calculation processing sequence of the plurality of pieces of inference sub-data based on the priority depending on the assigned evaluation score.

Thus, for example, the trained model execution device 10a can eliminate useless inference calculation processing in which the prescribed conversation contents cannot be found in spite of the inference calculation processing, and shorten the inference calculation processing time. Further, the trained model execution device 10a can preferentially perform the inference calculation processing on the inference sub-data that is highly likely to include the prescribed conversation contents, thereby ending the inference calculation processing early, and shortening the inference calculation processing time.

(13) In the trained model execution device 10 as set forth in any one of (1) to (4), the character data may be acquired as the inference data.

Thus, the trained model execution device 10 can find the character data, which is defined from mass character data, within a short inference calculation processing time.

(14) In the trained model execution device 10a as set forth in (13), the pre-processing unit 120a may perform the feature analysis for extracting the feature amount of the character data acquired as the inference data.

Thus, the trained model execution device 10a can optimally divide the inference character data into the plurality of pieces of inference sub-character data without acquiring the training data.

(15) In the trained model execution device 10a as set forth in (14), the pre-processing unit 120a may divide the inference data into the plurality of pieces of inference sub-data using the batch processing based on the result of the feature analysis.

Thus, the trained model execution device 10a can optimally divide the inference character data into the plurality of pieces of inference sub-character data without acquiring the training data.

(16) In the trained model execution device 10a as set forth in (14) or (15), the execution unit 130a may assign the evaluation score to each of the plurality of pieces of inference sub-data based on the result of the feature analysis, and optimize the inference calculation processing sequence of the plurality of pieces of inference sub-data based on the priority depending on the assigned evaluation score.

Thus, for example, the trained model execution device 10a can eliminate useless inference calculation processing in which the prescribed character data cannot be found in spite of the inference calculation processing performed thereon, and shorten the inference calculation processing time. Further, the trained model execution device 10a can preferentially perform the inference calculation processing on the inference sub-data that is highly likely to include the prescribed character data, thereby finishing the inference calculation processing early, and shortening the inference calculation processing time.

(17) In the trained model execution device 10b as set forth in any one of (1) to (4), the acquisition unit 110b may acquire the three-dimensional measurement data.

Thus, the trained model execution device 10b can optimally divide the inference data into the plurality of pieces of inference sub-data without acquiring the training data.

(18) In the trained model execution device 10b as set forth in (17), the pre-processing unit 120b may divide the inference data into the plurality of pieces of inference sub-data using the batch processing based on the three-dimensional measurement data.

Thus, the trained model execution device 10b can optimally divide the inference data into the plurality of pieces of inference sub-data without acquiring the training data.

(19) In the trained model execution device 10b as set forth in (17) or (18), the execution unit 130b may assign the evaluation score to each of the plurality of pieces of inference sub-data based on the three-dimensional measurement data, and optimize the inference calculation processing sequence of the plurality of pieces of inference sub-data based on the priority depending on the assigned evaluation score.

Thus, the trained model execution device 10b can eliminate useless inference calculation processing in which the candidates for the workpieces 50 to be picked cannot be found in spite of the inference calculation processing performed on the inference sub-data that is unlikely to include the workpieces 50 to be picked, and shorten the inference calculation processing time. Further, the trained model execution device 10b can preferentially perform the inference calculation processing on the inference sub-data that is highly likely to include the workpieces 50 to be picked, thereby quickly finding the number of candidates for the workpieces 50 specified in advance, finishing the inference calculation processing early, and shortening the inference calculation processing time.

(20) The inference calculation processing method according to the present disclosure is for inputting inference data to the trained model and executing the inference calculation processing for the inference data, and is implementable by a computer. The inference calculation processing method includes: an acquisition step of acquiring the inference data and the trained model; a pre-processing step of dividing the acquired inference data into a plurality of pieces of inference sub-data by way of batch processing; and an execution step of optimizing the inference calculation processing sequence of the plurality of pieces of inference sub-data, and executing the inference calculation processing for the inference data according to the optimized inference calculation processing sequence, based on each of at least one of the plurality of pieces of inference sub-data and the trained model.

According to the inference calculation processing method, the same effect as (1) can be obtained.

### EXPLANATION OF REFERENCE NUMERALS

1, 1A: Robot system
10, 10a, 10b: Trained model execution device as inference calculation processing device
11, 11a, 11b: Control unit
110, 110a, 110b: Acquisition unit
111: Data save unit
120, 120a, 120b: Pre-processing unit
121, 121a, 121b: Batch processing unit
122: Image processing unit
122a, 131: Feature analysis unit
123: Three-dimensional processing unit
130, 130a, 130b: Execution unit
132, 132a, 132b: Evaluation score calculation unit
133: Optimization calculation unit
134: Inference calculation processing unit
135: Inference result save unit
20: Robot control device
30: Robot
40: Image capturing device
45: Three-dimensional measurement device
50: Workpiece
60: Container

1. An inference calculation processing device that inputs inference data to a trained model and executes inference calculation processing for the inference data, the inference calculation processing device comprising:
an acquisition unit configured to acquire the inference data and the trained model;
a pre-processing unit configured to divide the acquired inference data into a plurality of pieces of inference sub-data by way of batch processing; and
an execution unit configured to optimize an inference calculation processing sequence of the plurality of pieces of inference sub-data, and execute the inference calculation processing for the inference data according to the optimized inference calculation processing sequence, based on each of at least one of the plurality of pieces of inference sub-data and the trained model.

2. The inference calculation processing device according to claim 1, wherein
the acquisition unit acquires training data that has been used in machine learning to generate the trained model.

3. The inference calculation processing device according to claim 2, wherein
the pre-processing unit performs the batch processing on the inference data based on the training data.

4. The inference calculation processing device according to claim 2, wherein
the execution unit performs matching processing between the training data and each of the plurality of pieces of inference sub-data, assigns an evaluation score according to a matching degree to each of the plurality of pieces of inference sub-data, and optimizes the inference calculation processing sequence of the plurality of pieces of inference sub-data based on priority depending on the assigned evaluation score.

5. The inference calculation processing device according to claim 1, wherein
the acquisition unit acquires image data as the inference data.

6. The inference calculation processing device according to claim 5, wherein
the pre-processing unit performs image processing on the image data acquired as the inference data.

7. The inference calculation processing device according to claim 6, wherein
the pre-processing unit performs the batch processing on the inference data based on a result of the image processing.

8. The inference calculation processing device according to claim 6, wherein
the execution unit assigns an evaluation score to each of the plurality of pieces of inference sub-data based on a result of the image processing, and optimizes the inference calculation processing sequence of the plurality of pieces of inference sub-data based on priority depending on the assigned evaluation score.

9. The inference calculation processing device according to claim 1, wherein
the acquisition unit acquires voice data as the inference data.

10. The inference calculation processing device according to claim 9, wherein
the pre-processing unit performs feature analysis on the voice data acquired as the inference data.

11. The inference calculation processing device according to claim 10, wherein
the pre-processing unit performs the batch processing on the inference data based on a result of the feature analysis.

12. The inference calculation processing device according to claim 10, wherein
the execution unit assigns an evaluation score to each of the plurality of pieces of inference sub-data based on a result of the feature analysis, and optimizes the inference calculation processing sequence of the plurality of pieces of inference sub-data based on priority depending on the assigned evaluation score.

13. The inference calculation processing device according to claim 1, wherein
the acquisition unit acquires character data as the inference data.

14. The inference calculation processing device according to claim 13, wherein
the pre-processing unit performs feature analysis on the character data acquired as the inference data.

15. The inference calculation processing device according to claim 14, wherein
the pre-processing unit performs batch processing on the inference data based on a result of feature analysis.

16. The inference calculation processing device according to claim 14, wherein
the execution unit assigns an evaluation score to each of the plurality of pieces of inference sub-data based on a result of the feature analysis, and optimizes the inference calculation processing sequence of the plurality of pieces of inference sub-data based on priority depending on the assigned evaluation score.

17. The inference calculation processing device according to claim 1, wherein
the acquisition unit acquires three-dimensional measurement data.

18. The inference calculation processing device according to claim 17, wherein
the pre-processing unit performs batch processing on the inference data based on the three-dimensional measurement data.

19. The inference calculation processing device according to claim 17, wherein
the execution unit assigns an evaluation score to each of the plurality of pieces of inference sub-data based on the three-dimensional measurement data, and optimizes the inference calculation processing sequence of the plurality of pieces of inference sub-data based on priority depending on the assigned evaluation score.

20. An inference calculation processing method for inputting inference data to a trained model and executing inference calculation processing for the inference data, the inference calculation processing method being implementable by a computer, and comprising:
an acquisition step of acquiring the inference data and the trained model;
a pre-processing step of dividing the acquired inference data into a plurality of pieces of inference sub-data by way of batch processing; and
an execution step of optimizing an inference calculation processing sequence of the plurality of pieces of inference sub-data, and the executing inference calculation processing for the inference data according to the optimized inference calculation processing sequence, based on each of at least one of the plurality of pieces of inference sub-data and the trained model.
